(19) United States
(12) Patent Application Publication
(10) Pub. No.: US 2011/0098916 A1
(43) Pub. Date: Apr. 28, 2011

(54) NAVIGATION METHOD OF MOBILE TERMINAL AND APPARATUS THEREOF

(76) Inventor: Jun-Young JANG, Seoul (KR)

(21) Appl. No.: 12/819,881

(22) Filed: Jun. 21, 2010

(30) Foreign Application Priority Data
Oct. 27, 2009 (KR) 10-2009-0102460

(51) Int. Cl. G01C 21/36; G08G 1/0969; G08G 1/16

(52) U.S. Cl. 701/201

(57) ABSTRACT

A navigation method and apparatus of a mobile terminal provide a vehicle driver with information about whether or not he can enter an intersection based on traffic light information and traffic volume information (a traffic congestion degree) to allow the vehicle driver to safely drive on the road (e.g., intersection). The navigation apparatus of a mobile terminal includes a display unit configured to display a route from a current location to a destination on map data, a communication unit configured to receive signal information of a traffic light and traffic volume information regarding an intersection on the route, and a controller configured to inform a vehicle driver about whether or not the vehicle driver can enter the intersection based on the signal information of the traffic light and the traffic volume information.

### CROSS-REFERENCE TO A RELATED APPLICATION

Pursuant to 35 U.S.C. §119(a), this application claims the benefit of earlier filing date and right of priority to Korean Application No. 10-2009-0102460 filed on Oct. 27, 2009, the contents of which are incorporated by reference herein in its entirety.

### BACKGROUND OF THE INVENTION

1. Field of the Invention

The present invention relates to a navigation method and apparatus of a mobile terminal.

2. Description of the Related Art

In general, the related art vehicle navigation apparatus generates road guide information based on a global positioning system (GPS) signal and map information and provides the generated road guide information to a user.

### SUMMARY OF THE INVENTION

An object of the present invention is to provide a navigation method and apparatus of a mobile terminal capable of providing signal information of a traffic light positioned at each road section to a vehicle driver to provide accurate information regarding a road situation to the vehicle driver.

Another object of the present invention is to provide a navigation method and apparatus of a mobile terminal capable of providing information regarding whether or not a road (e.g., an intersection) can be entered based on traffic light information and traffic volume information (i.e., a traffic congestion degree) to a vehicle driver, to allow the vehicle driver to safely drive on the road.

Still another object of the present invention is to provide a navigation method and apparatus of a mobile terminal capable of audibly providing signal information of a traffic light to improve user convenience.

Yet another object of the present invention is to provide a navigation method and apparatus of a mobile terminal capable of providing traffic light information and traffic violated vehicle information to a vehicle driver to allow the vehicle driver to safely drive on the road (e.g., an intersection).

According to an aspect of the present invention, there is provided a navigation apparatus of a mobile terminal, including: a display unit configured to display a route from a current location to a destination on data map; a communication unit configured to receive signal information of a traffic light and traffic volume information regarding an intersection on the route; and a controller configured to inform a vehicle driver about whether or not the vehicle driver is supposed to enter the intersection based on the signal information of the traffic light and the traffic volume information.

According to another aspect of the present invention, there is provided a navigation method of a mobile terminal, including: displaying, by a display unit, a route from a current location to a destination on map data; receiving, by a communication unit, signal information of a traffic light and traffic volume information regarding an intersection on the route; and informing a vehicle driver about whether or not the vehicle driver can enter the intersection based on the signal information of the traffic light and the traffic volume information.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a schematic block diagram of a mobile communication terminal according to an exemplary embodiment of the present invention;

FIG. 2 illustrates a proximity touch of the mobile communication terminal according to an exemplary embodiment of the present invention;

FIG. 3 is a schematic block diagram of a vehicle navigation system according to an exemplary embodiment of the present invention;

FIG. 4 is a schematic block diagram showing a telematics terminal according to an exemplary embodiment of the present invention;

FIG. 5 is a schematic block diagram of a navigation apparatus according to a first exemplary embodiment of the present invention;

FIG. 6 illustrates the format of TPEG information according to an exemplary embodiment of the present invention;

FIG. 7 illustrates traffic light information which is included in an application status container of FIG. 6 so as to be transmitted;

FIG. 8 is a flow chart illustrating the process of a method for providing traffic light information according to an exemplary embodiment of the present invention;

FIG. 9 illustrates an example of acquiring traffic light information at a current time point;

FIGS. 10 and 11 illustrate examples of displaying traffic light information on a display unit according to an exemplary embodiment of the present invention;

FIG. 12 is a flow chart illustrating the process of a navigation method (vehicle navigation method) according to a first exemplary embodiment of the present invention;

FIGS. 13 to 15 are overviews of screen display illustrating a voice guidance regarding a signal change according to the first exemplary embodiment of the present invention;

FIG. 16 is a flow chart illustrating the process of a method for guiding traveling using traffic light information and traffic violated vehicle information according to a second exemplary embodiment of the present invention;

FIG. 17 illustrates a plurality of traffic lights installed at an intersection according to the second exemplary embodiment of the present invention;

FIG. 18 is an overview of a screen display illustrating intersection entry danger information according to the second exemplary embodiment of the present invention;

FIGS. 19 to 21 are overviews of screen displays illustrating various examples of displaying intersection entry danger information according to the second exemplary embodiment of the present invention;

FIG. 22 is a flow chart illustrating the process of a navigation method (vehicle navigation method) according to a third exemplary embodiment of the present invention;

FIG. 23 is an overview of a screen display illustrating a traffic violated vehicle speed displayed together with intersection entry danger information according to the third exemplary embodiment of the present invention;

FIG. 24 is an overview of a screen display illustrating a method of displaying intersection entry danger information according to a fourth exemplary embodiment of the present invention; and

FIG. 25 is a flow chart illustrating the process of a navigation method (vehicle navigation method) according to a fifth exemplary embodiment of the present invention.

### DETAILED DESCRIPTION OF THE INVENTION

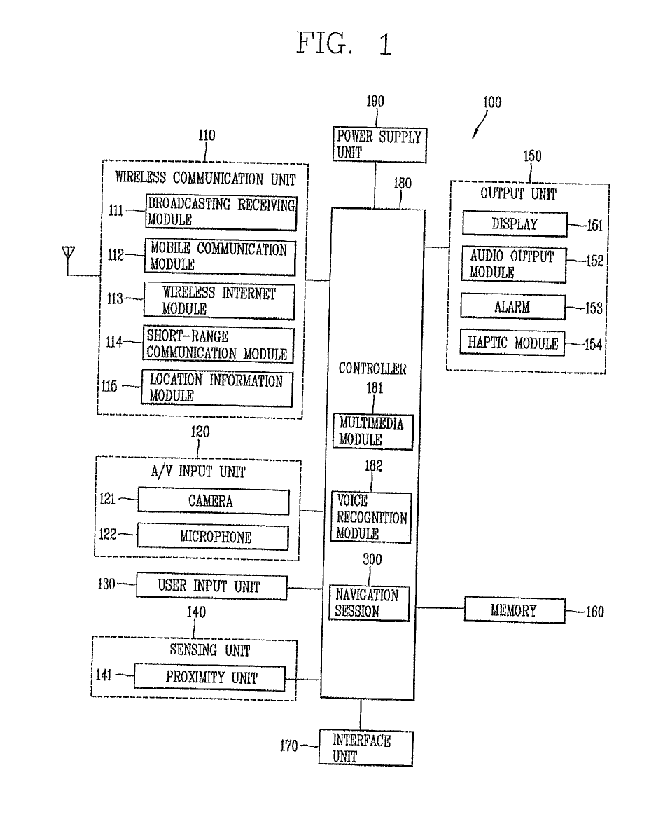

A navigation method and apparatus of a mobile terminal capable of providing information of a traffic light positioned at each road section to a vehicle driver to thus provide information regarding an accurate road situation to the vehicle driver, capable of providing information regarding whether or not an intersection can be entered based on traffic light information and traffic volume information (i.e., a traffic congestion degree) to a vehicle driver, to allow the vehicle driver to safely drive on the road, capable of audibly guiding signal information of a traffic light to thus obtain user convenience, and capable of providing traffic light information and traffic signal violation vehicle information to a vehicle driver to allow the vehicle driver stably drives on the road (e.g., an intersection) according to exemplary embodiments of the present invention will now be described with reference to FIGS. 1 to 26.

FIG. 1 is a schematic block diagram showing the configuration of a mobile communication terminal employing an image display apparatus according to an exemplary embodiment of the present invention. The mobile communication terminal 100 may be implemented in various forms such as mobile phones, smart phones, notebook computers, digital broadcast terminals, PDAs (Personal Digital Assistants), PMPs (Portable Multimedia Player), etc. All components of the mobile communication terminal 100 are operatively coupled and configured.

As shown in FIG. 1, the mobile communication terminal 100 includes a wireless communication unit 110, an A/V (Audio/Video) input unit 120, a user input unit 130, a sensing unit 140, an output unit 150, a memory 160, an interface unit 170, a controller 180, and a power supply unit 190, etc. FIG. 1 shows the mobile communication terminal 100 having various components, but it is understood that implementing all of the illustrated components is not a requirement. The mobile communication terminal 100 may be implemented by greater or fewer components.

The wireless communication unit 110 typically includes one or more components allowing radio communication between the mobile communication terminal 100 and a wireless communication system or a network in which the mobile communication terminal is located. For example, the wireless communication unit may include at least one of a broadcast receiving module 111, a mobile communication module 112, a wireless Internet module 113, a short-range communication module 114, and a location information module 115.

The broadcast receiving module 111 receives broadcast signals and/or broadcast associated information from an external broadcast management server (or other network entity) via a broadcast channel. The broadcast channel may include a satellite channel and/or a terrestrial channel. The broadcast management server may be a server that generates and transmits a broadcast signal and/or broadcast associated information or a server that receives a previously generated broadcast signal and/or broadcast associated information and transmits the same to a terminal. The broadcast associated information may refer to information associated with a broadcast channel, a broadcast program or a broadcast service provider. The broadcast signal may include a TV broadcast signal, a radio broadcast signal, a data broadcast signal, and the like. Also, the broadcast signal may further include a broadcast signal combined with a TV or radio broadcast signal.

The broadcast associated information may also be provided via a mobile communication network and, in this case, the broadcast associated information may be received by the mobile communication module 112. The broadcast signal may exist in various forms. For example, it may exist in the form of an electronic program guide (EPG) of digital multimedia broadcasting (DMB), electronic service guide (ESG) of digital video broadcast-handheld (DVB-H), and the like.

The broadcast receiving module 111 may be configured to receive signals broadcast by using various types of broadcast systems. In particular, the broadcast receiving module 111 may receive a digital broadcast by using a digital broadcast system such as multimedia broadcasting-terrestrial (DMB-T), digital multimedia broadcasting-satellite (DMB-S), digital video broadcast-handheld (DVB-H), the data broadcasting system known as media forward link only (MediaFLO®), integrated services digital broadcast-terrestrial (ISDB-T), etc. The broadcast receiving module 111 may be configured to be suitable for every broadcast system that provides a broadcast signal as well as the above-mentioned digital broadcast systems. Broadcast signals and/or broadcast-associated information received via the broadcast receiving module 111 may be stored in the memory 160 (or another type of storage medium).

The mobile communication module 112 transmits and/or receives radio signals to and/or from at least one of a base station (e.g., access point, Node B, etc.), an external terminal (e.g., other user devices) and a server (or other network entities). Such radio signals may include a voice call signal, a video call signal or various types of data according to text and/or multimedia message transmission and/or reception.

The wireless Internet module 113 supports wireless Internet access for the mobile communication terminal. This module may be internally or externally coupled to the terminal. Here, as the wireless Internet technique, a wireless local area network (WLAN), Wi-Fi, wireless broadband (WiBro), world interoperability for microwave access (WiMAX), high speed downlink packet access (HSDPA), and the like, may be used.

The short-range communication module 114 is a module for supporting short range communications. Some examples of short-range communication technology include Bluetooth™, Radio Frequency IDentification (RFID), Infrared Data Association (IrDA), Ultra-WideBand (UWB), ZigBee™, and the like.

The location information module 115 is a module for checking or acquiring a location (or position) of the mobile communication terminal (when the mobile communication terminal is located in a vehicle, the location of the vehicle can be checked). For example, the location information module 115 may be embodied by using a GPS (Global Positioning System) module that receives location information from a plurality of satellites. Here, the location information may include coordinate information represented by latitude and longitude values. For example, the GPS module may measure an accurate time and distance from three or more satellites, and accurately calculate a current location of the mobile communication terminal according to trigonometry based on the measured time and distances. A method of acquiring distance and time information from three satellites and performing error correction with a single satellite may be used. In particular, the GPS module may acquire an accurate time together with three-dimensional speed information as well as the location of the latitude, longitude and altitude values from the location information received from the satellites. As the location information module 115, a Wi-Fi position system and/or hybrid positioning system may be used.

The A/V input unit 120 is configured to receive an audio or video signal. The A/V input unit 120 may include a camera 121 (or other image capture device) and a microphone 122 (or other sound pick-up device). The camera 121 processes image data of still pictures or video obtained by an image capture device in a video capturing mode or an image capturing mode. The processed image frames may be displayed on a display unit 151 (or other visual output device).

The image frames processed by the camera 121 may be stored in the memory 160 (or other storage medium) or transmitted via the wireless communication unit 110. Two or more cameras 121 may be provided according to the configuration of the mobile communication terminal.

The microphone 122 may receive sounds (audible data) via a microphone (or the like) in a phone call mode, a recording mode, a voice recognition mode, and the like, and can process such sounds into audio data. The processed audio (voice) data may be converted for output into a format transmittable to a mobile communication base station (or other network entity) via the mobile communication module 112 in case of the phone call mode. The microphone 122 may implement various types of noise canceling (or suppression) algorithms to cancel (or suppress) noise or interference generated in the course of receiving and transmitting audio signals.

The user input unit 130 (or other user input device) may generate key input data from commands entered by a user to control various operations of the mobile communication terminal. The user input unit 130 allows the user to enter various types of information, and may include a keypad, a dome switch, a touch pad (e.g., a touch sensitive member that detects changes in resistance, pressure, capacitance, etc. due to being contacted) a jog wheel, a jog switch, and the like. In particular, when the touch pad is overlaid on the display unit 151 in a layered manner, it may form a touch screen.

The sensing unit 140 (or other detection means) detects a current status (or state) of the mobile communication terminal 100 such as an opened or closed state of the mobile communication terminal 100, a location of the mobile communication terminal 100, the presence or absence of user contact with the mobile communication terminal 100 (i.e., touch inputs), the orientation of the mobile communication terminal 100, an acceleration or deceleration movement and direction of the mobile communication terminal 100, etc., and generates commands or signals for controlling the operation of the mobile communication terminal 100. For example, when the mobile communication terminal 100 is implemented as a slide type mobile phone, the sensing unit 140 may sense whether the slide phone is opened or closed. In addition, the sensing unit 140 can detect whether or not the power supply unit 190 supplies power or whether or not the interface unit 170 is coupled with an external device.

The interface unit 170 (or other connection means) serves as an interface by which at least one external device may be connected with the mobile communication terminal 100. For example, the external devices may include wired or wireless headset ports, an external power supply (or battery charger) ports, wired or wireless data ports, memory card ports, ports for connecting a device having an identification module, audio input/output (I/O) ports, video I/O ports, earphone ports, or the like. Here, the identification module may be a memory chip (or other element with memory or storage capabilities) that stores various information for authenticating user's authority for using the mobile communication terminal 100 and may include a user identity module (UIM), a subscriber identity module (SIM) a universal subscriber identity module (USIM), and the like.

In addition, the device having the identification module (referred to as the ‘identifying device’, hereinafter) may take the form of a smart card. Accordingly, the identifying device may be connected with the terminal 100 via a port or other connection means. The interface unit 170 may be used to receive inputs (e.g., data, information, power, etc.) from an external device and transfer the received inputs to one or more elements within the mobile communication terminal 100 or may be used to transfer data between the mobile communication terminal and an external device.

The output unit 150 is configured to provide outputs in a visual, audible, and/or tactile manner (e.g., audio signal, video signal, alarm signal, vibration signal, etc.). The output unit 150 may include the display unit 151, an audio output module 152, an alarm unit 153, and the like.

The display unit 151 may display information processed in the mobile terminal 100. For example, when the mobile terminal 100 is in a phone call mode, the display unit 151 may display a User Interface (UI) or a Graphic User Interface (GUI) associated with a call or other communication (such as text messaging, multimedia file downloading, etc.). When the mobile terminal 100 is in a video call mode or image capturing mode, the display unit 151 may display a captured image and/or received image, a UI or GUI that shows videos or images and functions related thereto, and the like.

The display unit 151 may include at least one of a Liquid Crystal Display (LCD), a Thin Film Transistor-LCD (TFT-LCD), an Organic Light Emitting Diode (OLED) display, a flexible display, a three-dimensional (3D) display, or the like. The mobile terminal 100 may include two or more display units (or other display means) according to its particular desired embodiment. For example, the mobile terminal may include both an external display unit (not shown) and an internal display unit (not shown).

Meanwhile, when the display unit 151 and the touch pad are overlaid in a layered manner to form a touch screen, the display unit 151 may function as both an input device and an output device. The touch sensor may have the form of, for example, a touch film, a touch sheet, a touch pad, and the like.

The touch sensor may be configured to convert the pressure applied to a particular portion of the display unit 151 or a change in capacitance generated at a particular portion of the display unit 151 into an electrical input signal. The touch sensor may be configured to detect a touch input pressure as well as a touch input position and a touch input area. When there is a touch input with respect to the touch sensor, the corresponding signal(s) are sent to a touch controller (not shown). The touch controller processes the signal(s) and transmits corresponding data to the controller 180. Accordingly, the controller 180 can recognize a touched region of the display unit 151.

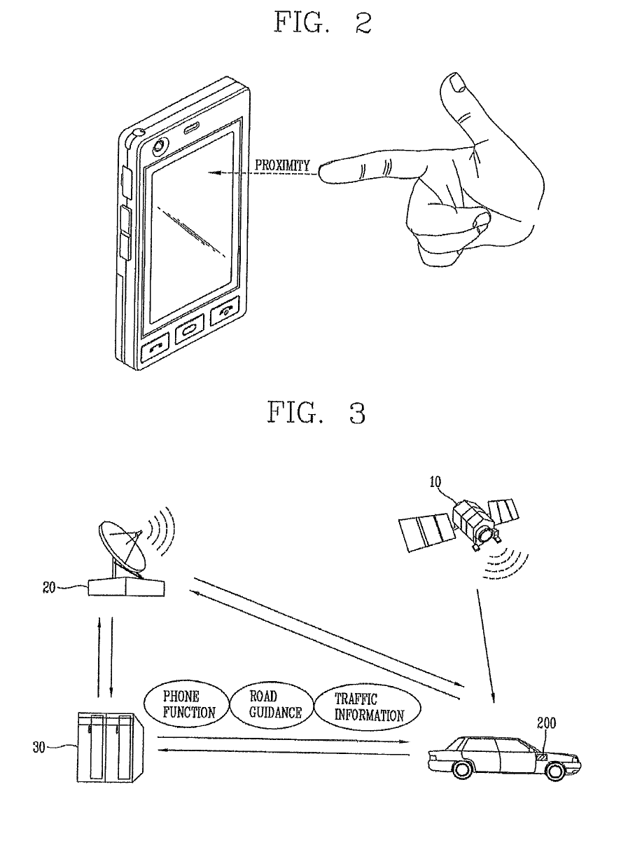

A proximity sensor 141 of the mobile communication terminal 100 will now be described with reference to FIG. 2.

FIG. 2 illustrates a proximity touch for explaining a data display method according to an exemplary embodiment of the present invention.

Proximity touch refers to recognition of the pointer positioned to be close to the touch screen without being in contact with the touch screen.

The proximity sensor 141 may be may be disposed within the mobile terminal covered by the touch screen or near the touch screen. The proximity sensor 141 refers to a sensor for detecting the presence or absence of an object that accesses a certain detect surface or an object that exists nearby by using the force of electromagnetism or infrared rays without a mechanical contact. Thus, the proximity sensor 141 has a longer life span compared with a contact type sensor, and it can be utilized for various purposes.

The example of the proximity sensor 141 may be a transmission type photo sensor, a direct reflection type photo sensor, a mirror-reflection type photo sensor, an RF oscillation type proximity sensor, a capacitance type proximity sensor, a magnetic proximity sensor, an infrared proximity sensor. When the touch screen is an electrostatic type touch screen, an approach of the pointer is detected based on a change in an electric field according to the approach of the pointer. In this case, the touch screen (touch sensor) may be classified as a proximity sensor.

In the following description, for the sake of brevity, recognition of the pointer positioned to be close to the touch screen without being contacted will be called a ‘proximity touch’, while recognition of actual contacting of the pointer on the touch screen will be called a ‘contact touch’. In this case, when the pointer is in the state of the proximity touch, it means that the pointer is positioned to correspond vertically to the touch screen.

The proximity sensor 141 detects a proximity touch and a proximity touch pattern (e.g., a proximity touch distance, a proximity touch speed, a proximity touch time, a proximity touch position, a proximity touch movement state, or the like), and information corresponding to the detected proximity touch operation and the proximity touch pattern can be outputted to the touch screen.

The audio output module 152 may output audio data received from the wireless communication unit 110 or stored in the memory 160 in a call signal reception mode, a call mode, a record mode, a voice recognition mode, a broadcast reception mode, and the like. Also, the audio output module 152 may provide audible outputs related to a particular function (e.g., a call signal reception sound, a message reception sound, etc.) performed in the mobile terminal 100. The audio output module 152 may include a receiver, a speaker, a buzzer, etc.

The alarm unit 153 outputs a signal for informing about an occurrence of an event of the mobile terminal 100. Events generated in the mobile terminal may include call signal reception, message reception, key signal inputs, a touch input etc. In addition to video or audio signals, the alarm unit 153 may output signals in a different manner, for example, to inform about an occurrence of an event. The video or audio signals may be also outputted via the audio output module 152, so the display unit 151 and the audio output module 152 may be classified as parts of the alarm unit 153.

A haptic module 154 generates various tactile effects the user may feel. A typical example of the tactile effects generated by the haptic module 154 is vibration. The strength and pattern of the haptic module 154 can be controlled. For example, different vibrations may be combined to be outputted or sequentially outputted.

Besides vibration, the haptic module 154 may generate various other tactile effects such as an effect by stimulation such as a pin arrangement vertically moving with respect to a contact skin, a spray force or suction force of air through a jet orifice or a suction opening, a contact on the skin, a contact of an electrode, electrostatic force, etc., an effect by reproducing the sense of cold and warmth using an element that can absorb or generate heat.

The haptic module 154 may be implemented to allow the user to feel a tactile effect through a muscle sensation such as fingers or arm of the user, as well as transferring the tactile effect through a direct contact. Two or more haptic modules 154 may be provided according to the configuration of the mobile terminal 100.

The memory 160 may store software programs used for the processing and controlling operations performed by the controller 180, or may temporarily store data (e.g., a phonebook, messages, still images, video, etc.) that are inputted or outputted. In addition, the memory 160 may store data regarding various patterns of vibrations and audio signals outputted when a touch is inputted to the touch screen.

The memory 160 may include at least one type of storage medium including a Flash memory, a hard disk, a multimedia card micro type, a card-type memory (e.g., SD or DX memory, etc), a Random Access Memory (RAM), a Static Random Access Memory (SRAM), a Read-Only Memory (ROM), an Electrically Erasable Programmable Read-Only Memory (EEPROM), a Programmable Read-Only memory (PROM), a magnetic memory, a magnetic disk, and an optical disk. Also, the mobile terminal 100 may be operated in relation to a web storage device that performs the storage function of the memory 160 over the Internet.

The interface unit 170 serves as an interface with every external device connected with the mobile terminal 100. For example, the external devices may transmit data to an external device, receives and transmits power to each element of the mobile terminal 100, or transmits internal data of the mobile terminal 100 to an external device. For example, the interface unit 170 may include wired or wireless headset ports, external power supply ports, wired or wireless data ports, memory card ports, ports for connecting a device having an identification module, audio input/output (I/O) ports, video I/O ports, earphone ports, or the like.

The identification module may be a chip that stores various information for authenticating the authority of using the mobile terminal 100 and may include a user identity module (UIM), a subscriber identity module (SIM) a universal subscriber identity module (USIM), and the like. In addition, the device having the identification module (referred to as ‘identifying device’, hereinafter) may take the form of a smart card. Accordingly, the identifying device may be connected with the terminal 100 via a port. The interface unit 170 may be used to receive inputs (e.g., data, information, power, etc.) from an external device and transfer the received inputs to one or more elements within the mobile terminal 100 or may be used to transfer data between the mobile terminal and an external device.

When the mobile terminal 100 is connected with an external cradle, the interface unit 170 may serve as a passage to allow power from the cradle to be supplied therethrough to the mobile terminal 100 or may serve as a passage to allow various command signals inputted by the user from the cradle to be transferred to the mobile terminal therethrough. Various command signals or power inputted from the cradle may operate as signals for recognizing that the mobile terminal is properly mounted on the cradle.

The controller 180 typically controls the general operations of the mobile terminal. For example, the controller 180 performs controlling and processing associated with voice calls, data communications, video calls, and the like. The controller 180 may include a multimedia module 181 for reproducing multimedia data. The multimedia module 181 may be configured within the controller 180 or may be configured to be separated from the controller 180.

The controller 180 may perform a pattern recognition processing to recognize a handwriting input or a picture drawing input performed on the touch screen as characters or images, respectively.

The power supply unit 190 receives external power or internal power and supplies appropriate power required for operating respective elements and components under the control of the controller 180.

Various embodiments described herein may be implemented in a computer-readable or its similar medium using, for example, software, hardware, or any combination thereof.

For hardware implementation, the embodiments described herein may be implemented by using at least one of application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electronic units designed to perform the functions described herein. In some cases, such embodiments may be implemented by the controller 180 itself.

For software implementation, the embodiments such as procedures or functions described herein may be implemented by separate software modules. Each software module may perform one or more functions or operations described herein. Software codes can be implemented by a software application written in any suitable programming language. The software codes may be stored in the memory 160 and executed by the controller 180.

The voice recognition module 182 recognizes a voice pronounced by the user and performs a corresponding function according to the recognized voice signal.

A navigation session 300 applied to the mobile terminal 100 displays a travel route on map data.

FIG. 3 is a schematic block diagram showing a vehicle navigation system according to an exemplary embodiment of the present invention.

As shown in FIG. 3, the vehicle navigation system includes an information providing center 30 for providing traffic information and various data (e.g., programs, execution files, etc.); and a telematics terminal 200 that is mounted within a vehicle, receives traffic information via a remote wireless communication network 20 and/or short-range wireless communication network, and provides a road guidance service based on a GPS signal received via an artificial satellite 10 and the traffic information. Here, the communication network may further include a wireline/wireless communication network such as a local area network (LAN), a wide area network (WAN).

Various traffic information (e.g., road traffic information, interested area information) including traffic light information are collected through the communication network, and the collected information are processed according to a transport protocol expert group (TPEG) standard in the information providing center 30 (e.g., a server). Accordingly, a broadcast station inserts traffic information including the traffic light information into a broadcast signal and broadcasts it to the vehicle.

The server reconfigures a digital broadcast service through various routes connected to a communication network, for example, an operator input, a wireline/wireless Internet, a transparent data channel (TDC), a multimedia object transport (MOC), various traffic information collected from a different server or a probe car, into a traffic information format such as a format in conformity with the TPEG standard, a standard for a traffic information service, and transmits the same to the broadcast station.

The server may generate a traffic information format of the TPEG standard including traffic light information, and transmit the same to the broadcast station.

The broadcast station includes the traffic information including the traffic light information which has been received from the server in a broadcast signal and transmits it wirelessly, so that a traffic information reception terminal, e.g., a navigation apparatus, mounted in the vehicle or the like can receive it. The traffic information includes the traffic light information and may include information regarding various traffic conditions required for operating the road, sea and air transportation such as an accident, a road condition, traffic congestion, road construction, a road closure, a public traffic network delay, and an air transportation holdup.

The broadcast station receives the processed traffic information including the traffic light information from the server and transmits it to the vehicle through a digital signal in conformity with various digital broadcast standards. In this case, the broadcast standards may include various digital broadcast standards such as a Europe-oriented digital audio broadcasting (DAB) standard based on Eureca-147 [ETSI EN 300 401], terrestrial or satellite digital multimedia broadcasting (DMB), terrestrial digital video broadcasting (DVB-T) standard, a digital video broadcasting-handheld (DVB-H), a media forward link only (MFLO) standard, and the like.

Also, the broadcast station may transmit the traffic information including the traffic light information via a wireline/wireless network such as the wireline/wireless Internet.

The vehicle refers to every carrier that can be implemented by using a mechanic and electronic device for the purpose of transporting people or objects such as general passenger cars, buses, trains, ships, aircraft, and the like.

The vehicle includes a traffic information reception terminal mounted therein, receives the traffic light information from the broadcast station by using the mounted traffic information reception terminal, processes the traffic light information, and transmits the processed traffic light information via text and/or audio to a user.

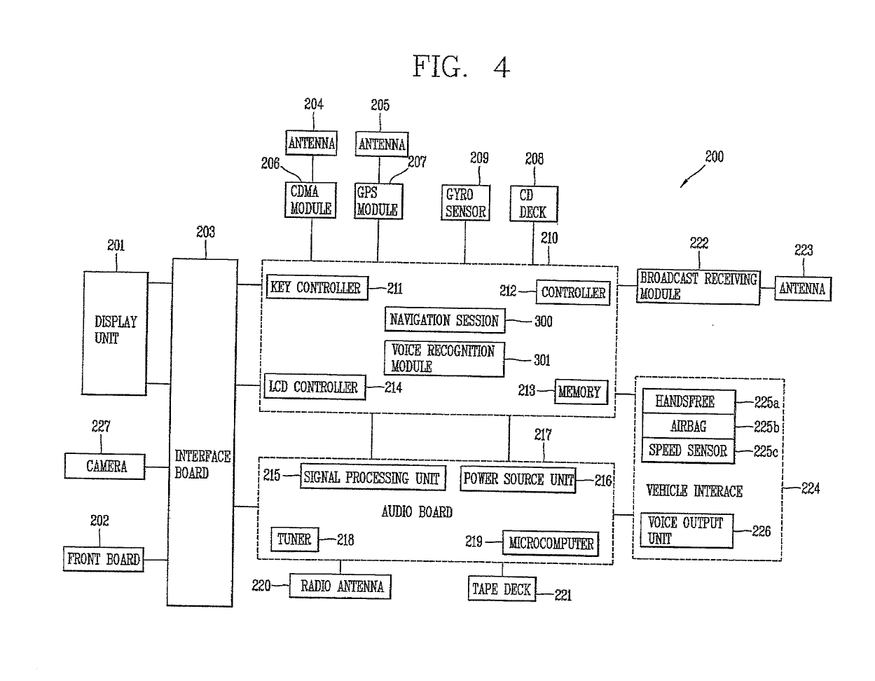

The configuration of the telematics terminal 200 according to an exemplary embodiment of the present invention will now be described with reference to FIG. 4.

FIG. 4 is a schematic block diagram showing a telematics terminal employing the vehicle navigation apparatus according to the present invention.

As shown in FIG. 4, the telematics terminal 200 includes a main board 210 including a CPU (Central Processing Unit) 212 for controlling the telematics terminal 200 overall, a memory 213 for storing various information, a key controller 211 for controlling various key signals, and an LCD controller 214 for controlling an LCD.

The memory 213 stores map information (map data) for displaying road guidance information on a digital map. Also, the memory 213 stores a traffic information collecting control algorithm for inputting traffic information according to the situation of a road along which the vehicle currently travels (runs), and information for controlling the algorithm.

The main board 210 includes a CDMA module 206, a mobile terminal having a unique device number as assigned and installed in the vehicle, a GPS module 207 for guiding a location of the vehicle, receiving a GPS signal for tracking a travel route from a start point to a destination, or transmitting traffic information collected by the user as a GPS signal, a CD deck 208 for reproducing a signal recorded in a CD (Compact Disk), a gyro sensor 209, or the like. The CDMA module 206 and the GPS module 207 receive signals via antennas 204 and 205.

A broadcast receiving module 222 is connected with the main board 210 and receives a TV signal via a TV antenna 223. A display unit (i.e., an LCD) 201 under the control of the LCD controller 214, a front board 202 under the control of the key controller 211, and a camera 227 for capturing the interior and/or the exterior of a vehicle are connected to the main board 210 via an interface board 203. The display unit 201 displays various video signals and character signals, and the front board 202 includes buttons for various key signal inputs and provides a key signal corresponding to a button selected by the user to the main board 210. Also, the display unit 201 includes a proximity sensor and a touch sensor (touch screen) of FIG. 2.

The front board 202 includes a menu key for directly inputting traffic information. The menu key may be configured to be controlled by the key controller 211.

An audio board 217 is connected with the main board 210 and processes various audio signals. The audio board 217 includes a microcomputer 219 for controlling the audio board 217, a tuner 218 for receiving a radio signal, a power source unit 216 for supplying power to the microcomputer 219 and a signal processing unit 215 for processing various voice signals.

The audio board 217 also includes a radio antenna 220 for receiving a radio signal and a tape deck 221 to play an audio tape. The audio board 217 may further include an amplifier 226 for outputting a voice signal processed by the audio board 217.

The amplifier 226 is connected to a vehicle interface 224. Namely, the audio board 217 and the main board 210 are connected to the vehicle interface 224. A handsfree 225a for inputting a voice signal, an airbag 225b configured for the security of a passenger, a speed sensor 225c for detecting the speed of the vehicle, or the like, may be connected to the vehicle interface 224. The speed sensor 225c calculates a vehicle speed and provides the calculated vehicle speed information to the CPU 212.

The navigation session 300 applied to the telematics terminal 200 generates road guidance information based on the map data and current location information of the vehicle and provides the generated road guidance information to a user.

The display unit 201 detects a proximity touch within a display window via a proximity sensor. For example, when a pointer (e.g., user's finger or stylus) is proximity-touched, the display unit 201 detects the position of the proximity touch and outputs position information corresponding to the detected position to the controller 212.

A voice recognition device (or a voice recognition module) 301 recognizes a voice pronounced by the user and performs a corresponding function according to the recognized voice signal.

The navigation session 300 applied to the telematics terminal displays a travel route on map data, and when the mobile terminal 100 is located within a pre-set distance from a blind spot included in the travel route, the navigation session 300 automatically forms a wireless network together with a terminal (e.g., a vehicle navigation apparatus) mounted in a nearby vehicle or a mobile communication terminal carried around by a nearby pedestrian via radio communication (e.g., a short-range wireless communication network) to receive location information of a nearby vehicle from the terminal mounted in the nearby vehicle and receive location information of the nearby pedestrian from the mobile communication terminal carried around by the nearby pedestrian.

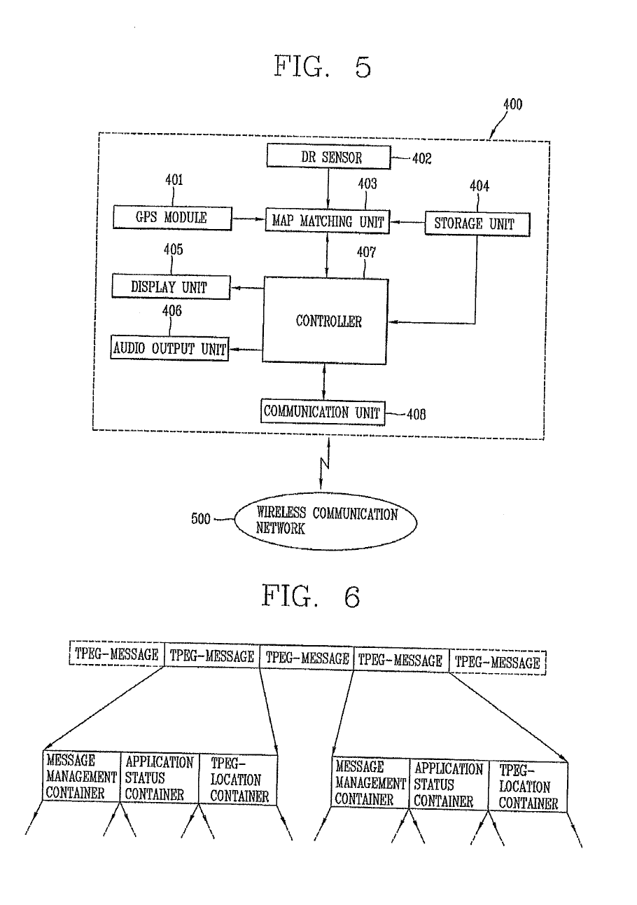

FIG. 5 is a schematic block diagram showing the configuration of the navigation apparatus 400 according to the first exemplary embodiment of the present invention.

The navigation (vehicle navigation) apparatus is divided into an in-dash type navigation apparatus and an on-dash type navigation apparatus according to an installation form in the vehicle. The in-dash type navigation apparatus is inserted in a certain space allocated within a dash board and fixedly mounted. The on-dash type navigation apparatus is mounted on the dash board of the vehicle or installed by using a certain support near the dash board. The on-dash type navigation apparatus is detachably attached, so it can be separated from the vehicle and carried around.

The navigation apparatus 400 according to the present exemplary embodiment includes the in-dash type navigation apparatus and the on-dash type navigation apparatus. In addition, the navigation apparatus 400 according to the present exemplary embodiment may include any information processing device that can receive and/or process traffic information such as various portable terminals performing a navigation function by interworking with a GPS receiver that receives a navigation message transmitted from a GPS satellite within the vehicle.

As shown in FIG. 5, the navigation apparatus 400 includes a GPS module 401 for receiving a GPS signal from a satellite and generating first vehicle location data of the navigation apparatus (regarded as the same location as the telematics terminal 200 or the mobile communication terminal 100) based on the received GPS signal; a DR (Dead-Reckoning) sensor 402 for generating second vehicle location data based on a travel direction and the speed of a vehicle; a storage unit (or a memory) 404 for storing map data and various information; a map matching unit 403 for generating an estimated vehicle location based on the first and second vehicle location data, matching the generated estimated vehicle location and a link (map matching link or a map matching road) in the map data stored in the storage unit 404, and outputting the matched map information (map matching results); a communication unit 408 for receiving real time traffic information from an information providing center and/or a nearby vehicle via a wireless communication network 500, receiving traffic light information, and performing call communication; a controller 407 for generating road guidance information based on the matched map information (map matching results); a display unit 405 for displaying a road guidance map (including information about a point of interest (POI)) included in the road guidance information and the traffic light information; and a voice output unit 406 for outputting road guidance voice information (road guidance voice message) included in the road guidance information and a voice signal corresponding to the traffic light information.

Here, the communication unit 408 may include a handsfree having a Bluetooth module and may receive a broadcast signal including traffic information in a TPEG format via an antenna from a broadcast station. The broadcast station may include traffic information according to a traffic information (TPEG) service or a binary format for scene (BIFS) data service and supplementary information such as various supplementary data, as well as video and audio data in conformity with various standards such as a terrestrial or satellite digital multimedia broadcasting (DMB), digital audio broadcasting (DAB), digital video broadcasting (DVB-T, DVB-H), and the like. Also, the communication unit 408 tunes a signal band providing traffic information, demodulates the tuned signal, and outputs the same to a TPEG decoder (included in the controller 407).

The TPEG decoder decodes the traffic information in the TPEG format and provides various information such as the traffic light information included in the traffic information to the controller 407.

The road guidance information may include various information related to traveling such as lane information, speed limit information, turn-by-turn information, traffic safety information, traffic guidance information, vehicle information, road search information, as well as the map data.

The signal received via the GPS module 401 may be configured to provide the location information of the terminal to the navigation apparatus 400 by using a wireless communication scheme such as 802.11, a standard of the wireless network for WLAN including wireless LAN, some infrared communication, and the like, 802.15, a standard for a wireless personal area network (PAN) including Bluetooth™, UWB, ZigBee, and the like, 802.16, a standard for a wireless metropolitan area network (MAN) broadband wireless access (BWA) including a fixed wireless access (FWA), and the like, and 802.20, a standard for the mobile Internet with respect to a mobile broadband wireless access (MBWA) including WiBro, WiMAX, and the like, proposed by IEEE (Institute of Electrical and Electronics Engineers).

The navigation apparatus 400 may further include an input unit. The input unit may select a user-desired function or receive information, and various devices such as a keypad, a touch screen, a jog shuttle, a microphone, and the like, may be used as the input unit.

The map matching unit 403 generates a vehicle estimated location based on the first and second vehicle location data, and reads map data corresponding to a travel route from the storage unit 404.

The map matching unit 403 matches the vehicle estimated location and a link (road) included in the map data, and outputs the matched map information (map matching results) to the controller 407. For example, the map matching unit 403 generates the vehicle estimated location based on the first and second location data, matches the generated vehicle estimated location and links in the map data stored in the storage unit 404 according to the link order, and outputs the matched map information (map matching results) to the controller 407. The map matching unit 403 may output information regarding road attributes such as single lane road, double lane road, and the like, included in the matched map information (map matching results). The function of the map matching unit 403 may be implemented in the controller 407.

The storage unit 404 stores map data. In this case, the stored map data includes geographic coordinates (or longitude/latitude coordinates) representing the latitude and longitude by DMS (Degree/Minute/Second) unit. Here, besides the geographic coordinates, universal transverse mercator (UTM) coordinates, universal polar system (UPS) coordinates, transverse mercator (TM) coordinates, and the like, may be also used as the stored map data.

The storage unit 404 stores various information such as various menu screen images, a point of interest (POI), function characteristics information according to a particular position of map data, and the like.

The storage unit 404 stores various user interfaces (UIs) and/or graphic UIs (GUIs).

The storage unit 404 stores data and programs required for operating the navigation apparatus 400.

The storage unit 404 stores destination information inputted from the user via the input unit. In this case, the destination information may be a destination or one of a destination and a start point.

The display unit 405 displays image information (or road guidance map) included in the road guidance information generated by the controller 407. Here, the display unit 405 includes a touch sensor (touch screen) and/or a proximity sensor. The road guidance information may include various information in relation to traveling (running, driving) such as lane information, speed limit information, turn-by-turn information, traffic safety information, traffic guidance information, vehicle information, road search information, and the like, as well as the map data.

When displaying the image information, the display unit 405 may display various contents such as various menu screen images, road guidance information, and the like, by using a user interface and/or a graphic user interface included in the storage unit 404. Here, the contents displayed on the display unit 405 may include various text or image data (including map data or various information data), and a menu screen image including data such as icons, list menus, combo boxes, and the like.

The voice output unit 406 outputs voice information included in road guidance information (or a voice message with respect to the road guidance information) generated by the controller 407. Here, the voice output unit 406 may be an amplifier or a speaker.

The controller 407 generates the road guidance information based on the matched map information and outputs the generated road guidance information to the display unit 405 and the voice output unit 406. Then, the display unit 405 displays the road guidance information.

The controller 407 receives real time traffic information from the information providing center and generates road guidance information.

The controller 407 may be connected to a call center via the communication unit 408 to perform call communication, or transmit or receive information between the navigation apparatus 400 and the call center. Here, the communication unit 408 may include a handsfree module having a Bluetooth™ function using a short-range radio communication scheme.

When a POI search menu is selected by the user, the controller 407 searches a POI located in a route from the current location to a destination, and displays the searched POI on the display unit 405. In this case, the controller 407 searches a POI (namely, a point at which the route does not need to be changed (researched), e.g., a POI positioned at left or right side of the traveling road) positioned on the route and/or a POI (namely, a point at which the route needs to be changed, e.g., a point at which the pre-set route needs to be changed in order to go through a nearby POI) positioned near the route, and displays the searched POI on the display unit 405.

Hereinafter, the format of the TPEG information will now be described with reference to FIG. 6.

FIG. 6 illustrates the format of TPEG information according to an exemplary embodiment of the present invention.

With reference to FIG. 6, the TPEG information includes a sequence of message segments (referred to as a ‘TPEG message’, hereinafter).

Each of the message segments may be applied to different applications. For example, each TPEG message may be applied to one of a TPEG-congestion and travel-time information application, a TPEG-road traffic message application, a TPEG-public transport information application, a TPEG-multimedia based traffic and travel information application, and other applications. In the present exemplary embodiment, traffic light information may be applied to any of the above-mentioned applications.

A unique identification number called an application identification (AID) is assigned to each of the TPEG applications. The AID is used to decode a received TPEG message by using the most appropriate application decoder.

An AID 0001(hex) is assigned to the TPEG-road traffic message application, an AID 0010(hex) is assigned to the TPEG-congestion and travel-time information application (TPEG-CTT), and an AID 0008(hex) is assigned to the TPEG-multimedia based traffic and travel information application.

The TPEG message includes a message management container, an application status container, and a TPEG location container.

Content of the application status container varies depending on the types of the TPEG message applications. The traffic light information according to the present exemplary embodiment may be included in the application status container and transmitted. For example, when the TPEG message is the TPEG congestion and travel-time information application (TPEG-CTT), the traffic light information may be included in the TPEG-CTT container, the application status container. In this case, the TPEG-CTT container may include congestion and travel time status information, congestion and travel time status prediction information, additional information, and the traffic light information according to the present exemplary embodiment of the present invention.

The congestion and travel time status information includes information regarding an average link speed, a travel time, a link delay, and a congestion type.

The congestion and travel time status prediction information includes information regarding an average speed prediction, a travel time prediction, and a congestion tendency.

The additional information describes supplementary information, auxiliary information, and the like, related to the congestion and travel time status information, in a text format.

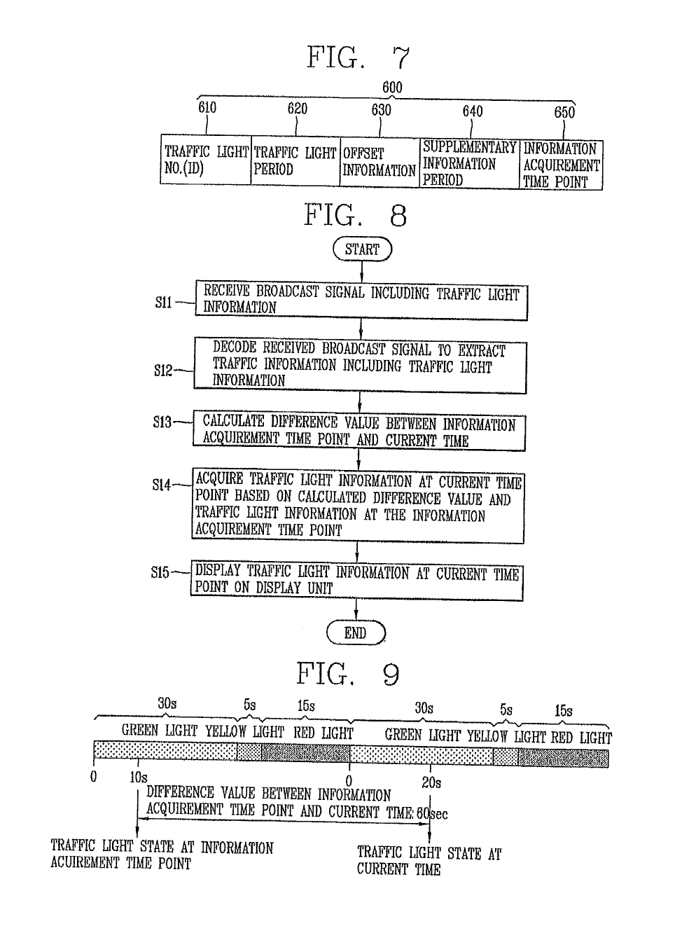

The traffic light information includes information regarding a traffic light number, a traffic light period, a signal of a traffic light at a time point at which the traffic light information was acquired, a lapse time duration from a time point at which a signal of the traffic light was changed to a time point at which the traffic light information was acquired, supplementary information, and the time point at which the traffic light information is acquired. This will be described in detail later with reference to FIG. 7. The TPEG location container includes location information regarding each link, namely, each road section. Messages transmitted by being included in the TPEG information are location-dependent and include information regarding a location.

FIG. 7 illustrates traffic light information which is included in the application status container of FIG. 6 so as to be transmitted.

With reference to FIG. 7, the traffic light information 600 includes a traffic light No. (ID) 610, a traffic light period 620, offset information 630, supplementary information 640, and information acquirement time point 650.

The traffic light number 610 indicates an ID of each of traffic lights to check a traffic light included in each road section. In the TPEG, a link ID is assigned to each road section, and the traffic light ID may be assigned in association with the link ID. For example, when three different traffic lights are included in a road section with a link ID ‘100’, each traffic light number may be defined as 100a, 100b, and 100c. This is merely an example, and the traffic light numbers may be defined in a different manner.

The traffic light period 620 indicates a time duration during which a traffic light maintains a current state. For example, when a traffic light includes three signals of a green traffic light, a yellow traffic light, and a red traffic light, the period of the green traffic light may be one minute, that of the yellow traffic light may be 5 seconds, and that of the red traffic light may be 30 seconds. Namely, when the time duration of one minute lapses from the time point at which the traffic light was changed to the green traffic light, the green traffic light is changed to the yellow traffic light, and when five seconds lapses from the point at which the green traffic light was changed to the yellow traffic light, the signal may be changed from the yellow traffic light to the red traffic light.

The offset information 630 includes information regarding a signal of a traffic light at the time point at which the traffic light information was acquired and a lapse time duration from a time point at which a signal of the traffic light was changed to a time point at which the traffic light information was acquired. For example, the offset information 630 may include information that a B traffic light is currently a red signal and information that 30 seconds has lapsed after the traffic light was changed to the red signal.

The supplementary information 640 includes information about whether or not the traffic light is turned on or off, whether the traffic light is in disorder, or whether or not a reversible lane can be used.

The information acquirement time point 650 includes the above-described traffic light information, namely, the information regarding a time point at which the current traffic light number 610, the traffic light period 620, the offset information, the supplementary information 640 were acquired.

FIG. 8 is a flow chart illustrating the process of a method for providing traffic light information according to an exemplary embodiment of the present invention.

As shown in FIG. 8, the communication unit 408 receives a broadcast signal including traffic light information from a broadcast station (S11). The broadcast signal includes the TPEG message, and the traffic light information may be included in the application status container of the TPEG message. The communication unit 508 may receive traffic information and/or the broadcast signal including the traffic light information via a vehicle sensor (not shown) installed on the road.

The TPEG decoder decodes the TPEG message included in the broadcast signal to extract the traffic light information and various traffic information included in the TPEG message (S12). The traffic light information includes the information regarding a time point at which the traffic light number, the traffic light period, the offset information, and the supplementary information were acquired.

The controller 407 calculates a difference value between the time point at which the traffic light information was acquired and a current time (S13).

The controller 407 acquires traffic light information of the current time point based on the calculated difference value and the traffic light information at the information acquirement time point (S14).

FIG. 9 illustrates an example of acquiring traffic light information at a current time point.

As shown in FIG. 9, it is assumed that the period of the green traffic light is 30[s], the period of the yellow traffic light is 5[s], and the period of the red traffic light is 15[s]. Such period information may be checked from the traffic light period 620. The state of the traffic light at the information acquirement time point is a state in which 10 seconds has lapsed since the traffic light was changed to the green traffic light, and this information may be confirmed with the offset information 630. Also, when the difference value between the calculated information acquirement time point and the current time is 60 [sec], the state of the traffic light at the current time point is a state in which 20 seconds has lapsed since the traffic light was changed to the green traffic light. Namely, the state of the traffic light at the current time point can be checked by delaying time by the calculated difference value from the information acquirement time point.

In this manner, when the traffic light information at the current time point is acquired, the controller 407 controls the display unit 405 to display the traffic light information at the current time point (S15).

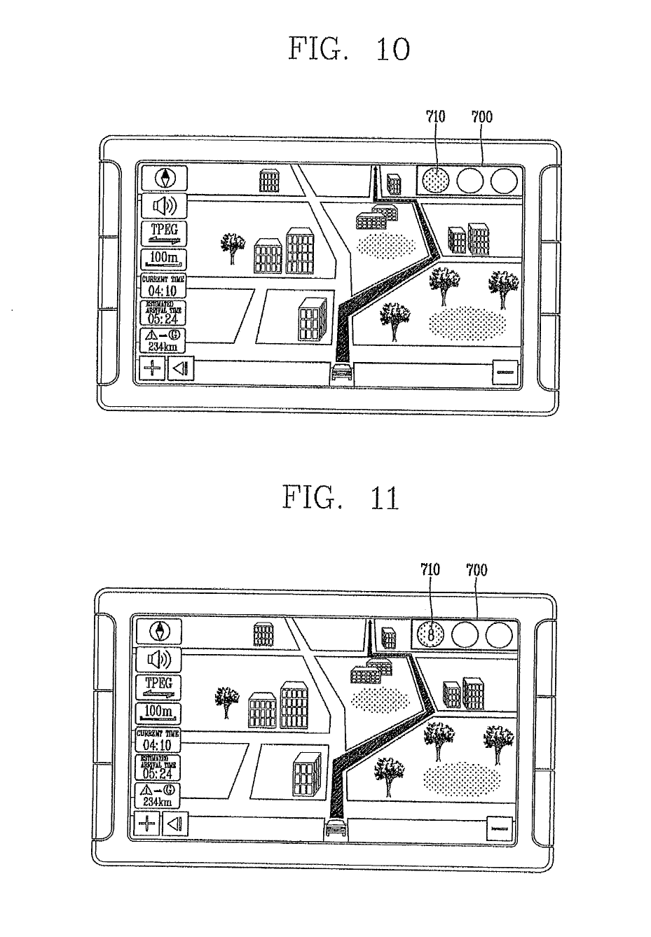

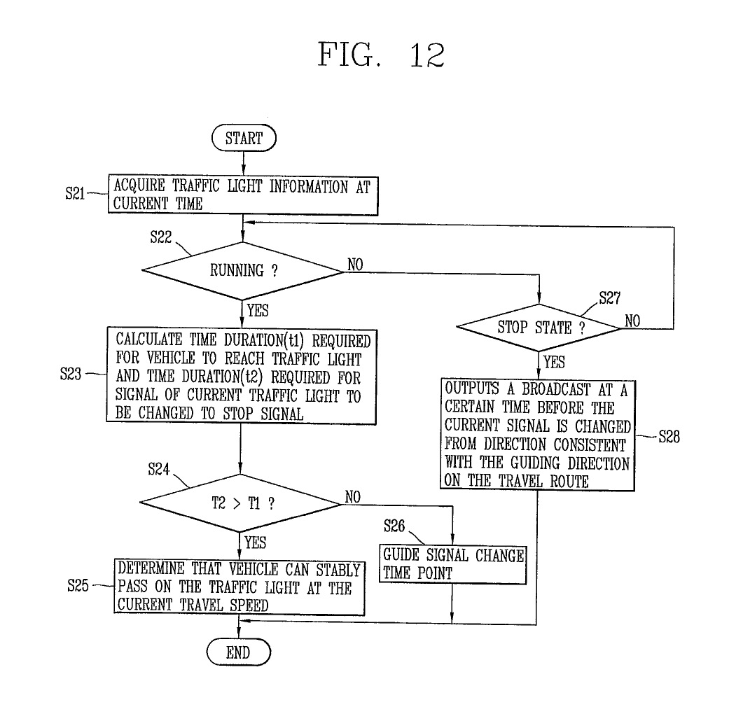

FIGS. 10 and 11 illustrate examples of displaying the traffic light information on the display unit according to an exemplary embodiment of the present invention.

As shown in FIG. 10, the controller 407 displays information 700 of the traffic light that a vehicle will reach in the road section in which the vehicle is currently located at an upper end of the right portion of the display unit 405. Because the signal of the red traffic light 710 is turned on, a driver should wait until when the signal is changed to the green traffic light.

As shown in FIG. 11, a count number, time information after which the current signal will be changed, may be displayed in addition to the traffic light information 700. For example, the signal of the red traffic light 710 is turned on and a count number ‘8’ is indicated within the red traffic light. This means that the signal of the red traffic light 710 will be changed to a different signal in eight seconds. The count number diminishes by 1 at every second and becomes 0 at the time point when the signal is changed. Namely, through the count number, the user (i.e., the driver) can easily check the time point at which the signal will be changed, and quickly cope with the change in the signal.

FIG. 12 is a flow chart illustrating the process of a navigation method (vehicle navigation method) according to a first exemplary embodiment of the present invention. Specifically, FIG. 12 is a flow chart illustrating the process of a travel guiding method using traffic light information. In the present exemplary embodiment, it is assumed that the traffic light information is included in the TPEG congestion and travel time information application message and transmitted.

First, the communication unit 408 acquires traffic light information at a current time point (S21).

The controller 407 checks whether or not the vehicle is currently driving or in a stop state (S22). Here, whether or not the vehicle is driving or in a stop state may be checked from GPS data inputted via the GPS module 401 or data inputted from a wheel speed sensor (not shown) that provides average speed information of a vehicle.

When the vehicle is currently driving, the controller 407 calculates a time duration t1 required for the vehicle to reach the traffic light from the current time point, and calculates a time duration t2 required for the signal of the current traffic light to be changed to a stop signal from the current time point (S23). Here, the time duration t1 required for the vehicle to reach the traffic light may be calculated by using an average speed of the vehicle, an average link speed, a travel time, and the like. The average speed of the vehicle may be checked from data provided from the wheel speed sensor (not shown), and the average link speed or the travel time may be checked from the congestion and travel time status information included in the TEPG-CTT container.

The controller 407 determines whether or not the time duration t2 during which the signal of the current traffic light is changed to a stop signal is larger than the time duration t1 taken for the vehicle to reach the traffic light (S24). If the time duration t2 during which the signal of the current traffic light is changed to a stop signal is larger than the time duration t1 taken for the vehicle to reach the traffic light, the controller 407 determines that the vehicle can safely pass through the traffic light at the current travel speed, generates an intersection entry safe message, and outputs the intersection entry safe message to the display unit 405 and/or to the voice output unit 406 (S25). The information of whether a vehicle may safely pass through an intersection is referred to as a traffic light signal navigation information. Here, the current traffic light refers to a traffic light corresponding to a route from the current location to a destination.

Meanwhile, if the time duration t2 during which the signal of the current traffic light is changed to a stop signal is smaller than the time duration t1 taken for the vehicle to reach the traffic light, the controller 407 outputs a guidance voice regarding a signal change time point via the voice output unit 406 (S26). Namely, the controller 407 determines that the vehicle cannot safely pass through the traffic light and outputs a guidance voice regarding a signal change at a certain time point before the signal of the traffic light is changed.

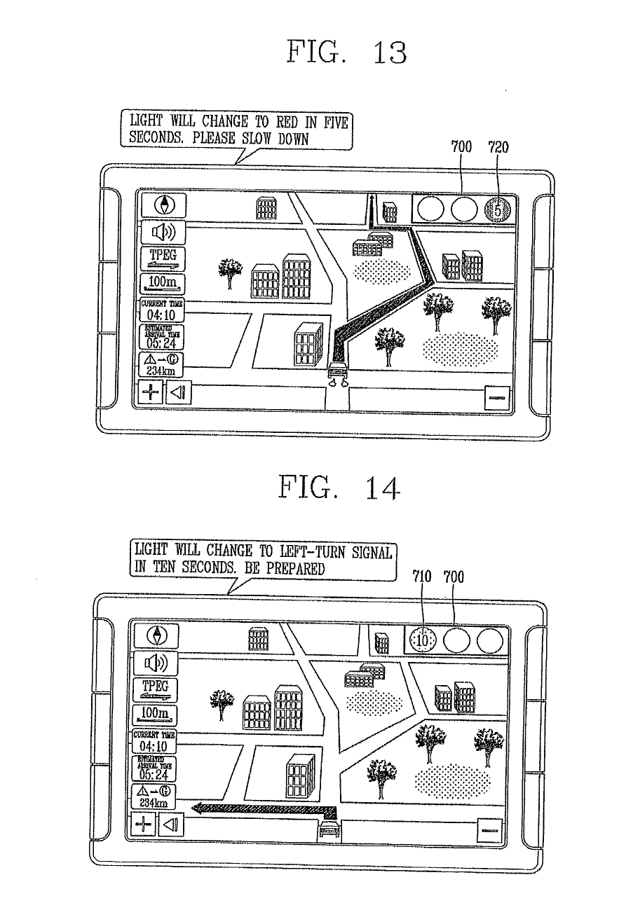

With reference to FIG. 13, although the traffic light that the vehicle will reach during its driving is currently green traffic light 720, if the controller 407 determines that the vehicle cannot pass through the corresponding signal in consideration of the average speed of the vehicle, it may output a guidance voice such as ‘Light will change to red in five seconds (i.e., ‘Red light in 5 seconds). Please slow down’ via the voice output unit 406.

Meanwhile, when the vehicle is in a stop state (S27), the controller 407 outputs a broadcast via the voice output unit at a certain time before the current signal is changed from the direction consistent with the guiding direction on the travel route (S28).

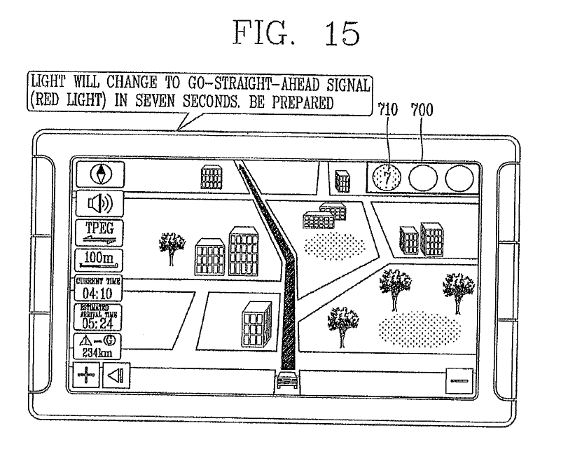

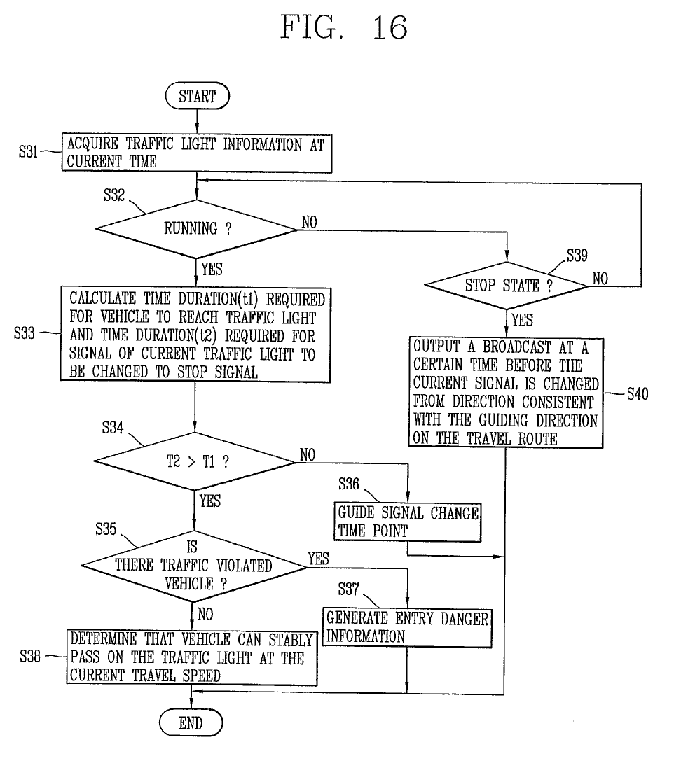

FIGS. 14 and 15 are overviews of screen display illustrating the vehicle in a stop state in the intersection at the red signal. For example, the controller 407 may output a broadcast such as “Light will change to left-turn signal in ten seconds. Be prepared” at a certain time before the red signal is changed to a left-turn signal, the signal of the direction consistent with the left direction, the guiding direction, on the travel route, for example, before 10 seconds, via the voice output unit 406.

Also, the controller 407 may output a broadcast such as ‘Light will change to go-straight-ahead signal (red light) in seven seconds. Be prepared’ at a certain time before the red signal is changed to the go-straight-ahead signal, the signal of the direction consistent with the go-straight-ahead direction, the guiding direction, on the travel route, for example, before seven seconds, via the voice output unit 406.

In the above-mentioned exemplary embodiment, the traffic light information is transmitted by being included in the CTT container of the TPEG congestion traffic information message, but of course, the traffic light information can be included in a different TPEG application and transmitted.

Hereinafter, a navigation apparatus and method of a mobile terminal according to a second exemplary embodiment of the present invention will now be described with reference to FIGS. 15, 16, and 17. Here, the navigation apparatus and method according to the second exemplary embodiment of the present invention may be applicable to various terminals such as a smart phone, a notebook computer, a personal digital assistant (PDA), a portable multimedia player (PMP) as well as to the mobile communication terminal 100, the telematics terminal 200, and the navigation apparatus 400.

The navigation apparatus 400 of the mobile terminal according to the second exemplary embodiment of the present invention includes a GPS module 401 for receiving a GPS signal from a satellite and generating first vehicle location data of the navigation apparatus (regarded as the same location as the telematics terminal 200 or the mobile communication terminal 100) based on the received GPS signal; a DR (Dead-Reckoning) sensor 402 for generating second vehicle location data based on a travel direction and the speed of a vehicle; a storage unit (or a memory) 404 for storing map data and various information; a map matching unit 403 for generating an estimated vehicle location based on the first and second vehicle location data, matching the generated estimated vehicle location and a link (map matching link or a map matching road) in the map data stored in the storage unit 404, and outputting the matched map information (map matching results); a communication unit 408 for receiving real time traffic information from an information providing center and or from a nearby vehicle via a wireless communication network 500, receiving traffic light information and traffic violated vehicle information, and performing call communication; a controller 407 for generating road guidance information based on the matched map information (map matching results), and determining whether or not an intersection can be entered based on the traffic light information and the traffic violated vehicle information when the vehicle enters the intersection on the route; a display unit 405 for displaying a road guidance map (including information about a point of interest (POI)) included in the road guidance information and the traffic light information; and a voice output unit 406 for outputting road guidance voice information (road guidance voice message) included in the road guidance information and a voice signal corresponding to the traffic light information.

Here, each traffic light installed at the intersection detects a traffic violated vehicle based on a vehicle detection signal detected by a vehicle sensor (not shown) buried in the road and transmits the detected traffic violated vehicle information to the communication unit 408 of the navigation apparatus 400 via a wireless communication network. A camera (not shown) installed at each of the traffic lights may capture an image of a traffic violated vehicle, include the captured image of the traffic violated vehicle in the traffic violated vehicle information, and transmit the traffic violated vehicle information having the captured image of the traffic violated vehicle to the communication unit 408. A traffic violated vehicle is one that has entered the intersection in violation of a traffic light or one that is liable to cause a collision with the vehicle having the navigation apparatus.

Also, each of the traffic lights at the intersection transmits information about a vehicle flow in a common section and in an individual section of the intersection from the vehicle sensor installed on the road to every nearby vehicle. The technique of detecting the traffic violated vehicle is a conventional art, so its detailed description will be omitted.

Each of the traffic lights at the intersection may transmit traffic light location information (GPS data), a vehicle flow detection (e.g., vehicle flow detection in the directions of east, west, south and north roads), traffic light signal information, time duration remaining until before a current signal is changed to a next signal, whether or not there is a vehicle which has entered the intersection, a location of the corresponding vehicle, and speed information of the vehicle to the nearby vehicle(s) via the wireless communication network (e.g., a wireless LAN (Bluetooth, 802.11n, etc. protocol).

Also, the traffic light may transmit a time duration remaining until before the signal of the traffic light is changed in real time to the communication unit 408 via the short-range wireless communication network (e.g., a wireless LAN (Bluetooth, 802.11n, etc. protocol). In this case, the controller 407 displays the ‘time duration remaining until before the signal of the traffic light is changed’ which has been transmitted via the communication unit 408 on the display unit 405. The ‘time duration remaining until before the signal of the traffic light is changed’ may be included in the traffic light information.

FIG. 16 is a flow chart illustrating the process of a method for guiding traveling using traffic light information and traffic violated vehicle information according to the second exemplary embodiment of the present invention. The navigation apparatus and method allowing for stably entering the intersection based on traffic violated vehicle information as well as traffic light information according to the second exemplary embodiment of the present invention will now be described.

First, the communication unit 408 acquires traffic light information at a current time point (S31). For example, the communication unit 408 receives traffic light information and traffic light location information from a plurality of traffic lights installed at the intersection, and outputs the received information to the controller 407. In this case, the controller 407 determines a traffic light located in the current traveling direction of a vehicle by comparing traffic light location information and the current traveling direction of the vehicle, extracts traffic light information which has been transmitted from the determined traffic light, and displays the extracted traffic light information to the display unit 405.

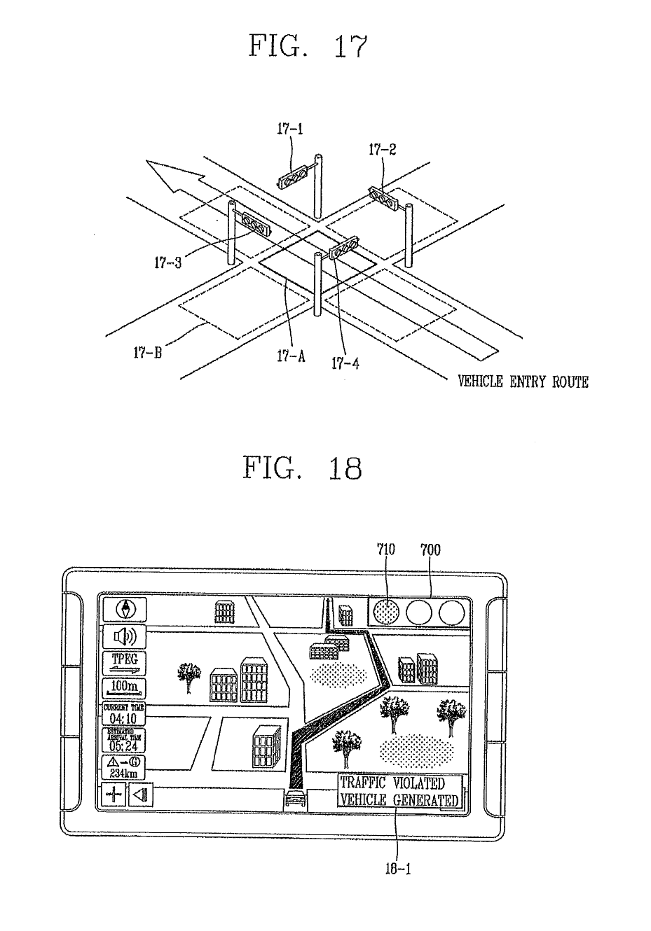

Hereinafter, the plurality of traffic lights installed at the intersection will now be described with reference to FIG. 17.

FIG. 17 illustrates a plurality of traffic lights installed at an intersection according to the second exemplary embodiment of the present invention.

As shown in FIG. 17, the communication unit 408 receives traffic light information and traffic light location information from a plurality of traffic lights 17-1, 17-2, 17-3, and 17-4 installed at the intersection, and outputs the received information to the controller 407. In this case, the controller 407 determines the traffic light (e.g., 17-4) located in the current traveling direction of the vehicle by comparing each traffic light location information and the current traveling direction (vehicle entering route) of the vehicle, extracts only the traffic light information transmitted from the determined traffic light 17-4, and displays the extracted traffic light information on the display unit 405. Also, each of the traffic lights 17-1, 17-2, 17-3, and 17-4 at the intersection transmit information about a vehicle flow in the common section 17-A and the individual section 17-B of the intersection from the vehicle sensor installed on the road to every vehicle around. Meanwhile, each of the traffic lights 17-1, 17-2, 17-3, and 17-4 at the intersection may receive a signal reflected from the vehicle by using radar of 60 GHz, measure the speed and type of the vehicle, a traffic volume, and the like, to provide traffic information. This is a known art also disclosed in Korean Laid Open Publication No. 2004-0007377.

The controller 407 checks whether or not the vehicle is currently driving or in a stop state (S32). Here, the controller 407 may check whether or not the vehicle is currently driving or in a stop state from GPS data inputted via the GPS module 401 or data inputted from a wheel speed sensor (not shown) that provides average speed information of a vehicle.

When the vehicle is currently driving, the controller 407 calculates a time duration t1 required for the vehicle to reach the traffic light from the current time point, and calculates a time duration t2 required for the signal of the current traffic light (e.g., the vehicle travel signal (green)) to be changed to a stop signal (e.g., the vehicle stop signal (red)) from the current time point (S33). Here, the controller calculates the distance from the location of the traffic light to the current location of the vehicle based on the location information of the traffic light and divides the calculated distance by a current speed value of the vehicle to obtain the time t1 required for the vehicle to reach the traffic light.

The controller 407 determines whether or not the time duration t2 during which the signal of the current traffic light is changed to a stop signal is larger than the time duration t1 taken for the vehicle to reach the traffic light (S34). If the time duration t2 during which the signal of the current traffic light is changed to a stop signal is smaller than the time duration t1 taken for the vehicle to reach the traffic light, the controller 407 outputs a guidance voice regarding a signal change time point via the voice output unit 406 (S36). Namely, the controller 407 determines that the vehicle cannot safely pass through the traffic light and outputs a guidance voice regarding a signal change at a certain time point before the signal of the traffic light is changed to red.

Meanwhile, if the time duration t2 during which the signal of the current traffic light is changed to a stop signal is larger than the time duration t1 taken for the vehicle to reach the traffic light, the controller 407 determines whether or not there is a traffic violated vehicle (e.g., a traffic violated vehicle at the intersection) (S35). For example, each of the traffic lights installed at the intersection detects a traffic violated vehicle based on a vehicle detection signal detected by the vehicle sensor (not shown) buried in the road and transmits the detected traffic violated vehicle information to the communication unit 408 of the navigation apparatus 400 via the wireless communication network.

When the traffic violated vehicle information is received while the time duration t2 during which the signal of the current traffic light is changed to a stop signal is larger than the time duration t1 taken for the vehicle to reach the traffic light, the controller 407 generates intersection entry danger information and outputs the generated intersection entry danger information to the display unit 405 and/or to the voice output unit 406 (S37).

Hereinafter, the intersection entry danger information will now be described with reference to FIGS. 18 to 21.

FIG. 18 is an overview of a screen display illustrating intersection entry danger information according to the second exemplary embodiment of the present invention.

As shown in FIG. 18, when the time duration t2 during which the signal of the current traffic light (e.g., green signal) is changed to a stop signal (e.g., a red signal) is larger than the time duration t1 taken for the vehicle to reach the traffic light and the traffic violated vehicle information is received, the controller 407 generates intersection entry danger information (e.g., generation of a traffic violated vehicle) 18-1 and displays the generated intersection entry danger information 18-1 on the display unit 405. Also, the controller 407 may generate a voice signal (e.g., ‘There is a traffic violated vehicle. Please make safe driving’) corresponding to the generated intersection entry danger information 18-1 and output the voice signal to the voice output unit 406.

If no traffic violated vehicle information is received while the time duration t2 during which the signal of the current traffic light (e.g., green signal) is changed to a stop signal (e.g., a red signal) is larger than the time duration t1 taken for the vehicle to reach the traffic light, the controller 407 determines that the vehicle can safely pass through the traffic light at the current traveling speed (S38).

Meanwhile, when the vehicle is in a stop state (S39), the controller 407 outputs a broadcast via the voice output unit 406 at a certain time before the signal is changed to the direction consistent with the guiding direction in the travel route (S40).

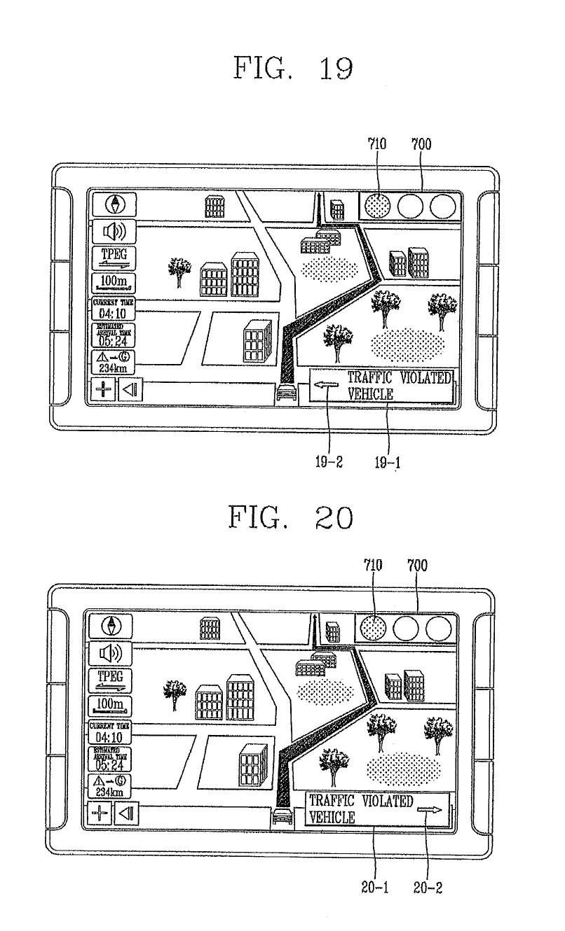

Hereinafter, various examples of displaying intersection entry danger information according to an exemplary embodiment of the present invention will now be described with reference to FIGS. 19 to 21.

FIGS. 19 to 21 are overviews of screen displays illustrating various examples of displaying intersection entry danger information according to the second exemplary embodiment of the present invention.

As shown in FIG. 19, when the time duration t2 during which the signal of the current traffic light (e.g., green signal) is changed to a stop signal (e.g., a red signal) is larger than the time duration t1 taken for the vehicle to reach the traffic light and the traffic violated vehicle information is received, the controller 407 detects a traffic light which has transmitted the traffic violated vehicle information via the traffic light location information. If the detected traffic light is currently positioned at the left side of the vehicle based on the current location of the vehicle, the controller recognizes (regards) that the traffic violated vehicle has violated the traffic on the left road based on the current location of the vehicle and generates information 19-2 (e.g., an icon or a symbol (e.g., an arrow indicating the left direction) indicating the direction in which the recognized traffic violated vehicle is located (e.g., the left direction) together with the intersection entry danger information 19-1, and displays the generated information 19-2 and the intersection entry danger information 19-1 on the display unit 405. In this case, the controller 407 may generate voice information (e.g., ‘There is a traffic violated vehicle at the left side. Please make a safe driving’) corresponding to the intersection entry danger information 19-1 and the direction information 19-2 indicating that the traffic violated vehicle was generated, and output the voice signal to the voice output unit 406.

As shown in FIG. 20, when the time duration t2 during which the signal of the current traffic light (e.g., green signal) is changed to a stop signal (e.g., a red signal) is larger than the time duration t1 taken for the vehicle to reach the traffic light and the traffic violated vehicle information is received, the controller 407 detects a traffic light which has transmitted the traffic violated vehicle information via the traffic light location information. If the detected traffic light is currently positioned at the right side of the vehicle based on the current location of the vehicle, the controller recognizes (regards) that the traffic violated vehicle has violated the traffic on the right road based on the current location of the vehicle and generates information 20-2 (e.g., an icon or a symbol (e.g., an arrow indicating the right direction) indicating the direction in which the recognized traffic violated vehicle is located (e.g., the right direction) together with the intersection entry danger information 20-1, and displays the generated information 20-2 and the intersection entry danger information 20-1 on the display unit 405. In this case, the controller 407 may generate voice information (e.g., ‘There is a traffic violated vehicle at the right side. Please make a safe driving’) corresponding to the intersection entry danger information 20-1 and the direction information 20-2 indicating that the traffic violated vehicle was generated, and output the voice signal to the voice output unit 406.

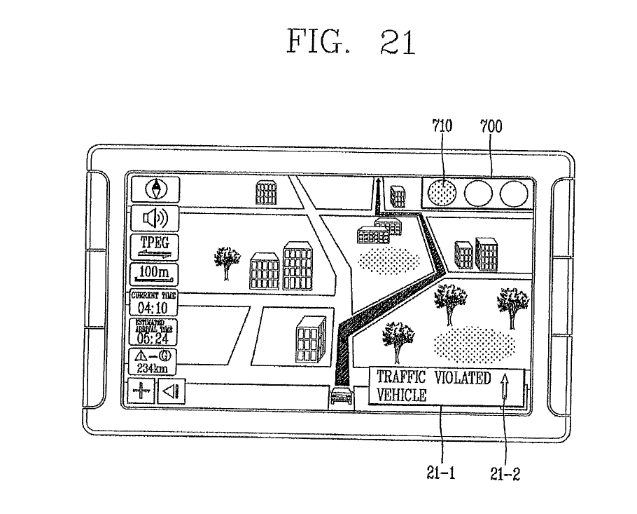

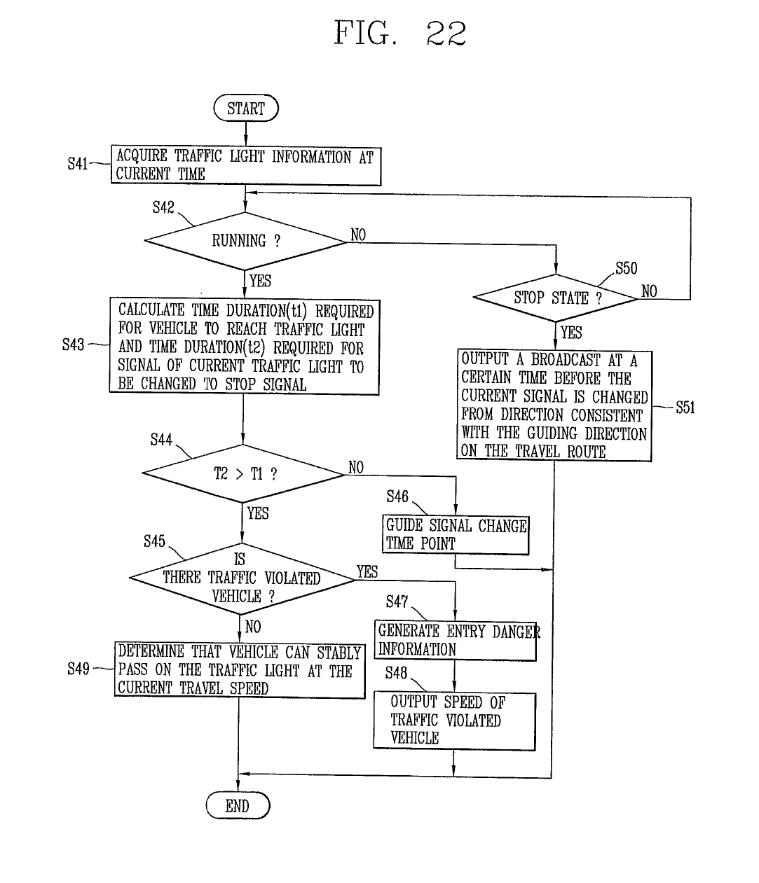

As shown in FIG. 21, when the time duration t2 during which the signal of the current traffic light (e.g., green signal) is changed to a stop signal (e.g., a red signal) is larger than the time duration t1 taken for the vehicle to reach the traffic light and the traffic violated vehicle information is received, the controller 407 detects a traffic light which has transmitted the traffic violated vehicle information via the traffic light location information. If the detected traffic light is currently positioned at the front side of the vehicle based on the current location of the vehicle, the controller recognizes (regards) that the traffic violated vehicle has violated the traffic on the front road based on the current location of the vehicle and generates information 21-2 (e.g., an icon or a symbol (e.g., an arrow indicating the forward direction) indicating the direction in which the recognized traffic violated vehicle is located (e.g., the forward direction) together with the intersection entry danger information 21-1, and displays the generated information 21-2 and the intersection entry danger information 21-1 on the display unit 405. In this case, the controller 407 may generate voice information (e.g., ‘There is a traffic violated vehicle at the front side. Please make a safe driving’) corresponding to the intersection entry danger information 21-1 and the direction information 21-2 indicating that the traffic violated vehicle was generated, and output the voice signal to the voice output unit 406.

Hereinafter, a navigation apparatus and method of a mobile terminal according to a third exemplary embodiment of the present invention will now be described with reference to FIGS. 5, 22, and 23. Here, the navigation apparatus and method according to the third exemplary embodiment of the present invention may be applicable to various terminals such as a smart phone, a notebook computer, a personal digital assistant (PDA), a portable multimedia player (PMP) as well as to the mobile communication terminal 100, the telematics terminal 200, and the navigation apparatus 400.

The navigation apparatus 400 of the mobile terminal according to the third exemplary embodiment of the present invention includes a GPS module 401 for receiving a GPS signal from a satellite and generating first vehicle location data of the navigation apparatus (regarded as the same location as the telematics terminal 200 or the mobile communication terminal 100) based on the received GPS signal; a DR (Dead-Reckoning) sensor 402 for generating second vehicle location data based on a travel direction and the speed of a vehicle; a storage unit (or a memory) 404 for storing map data and various information; a map matching unit 403 for generating an estimated vehicle location based on the first and second vehicle location data, matching the generated estimated vehicle location and a link (map matching link or a map matching road) in the map data stored in the storage unit 404, and outputting the matched map information (map matching results); a communication unit 408 for receiving real time traffic information from an information providing center and or from a nearby vehicle via a wireless communication network 500, receiving traffic light information and traffic violated vehicle information (including speed information of the traffic violated vehicle), and performing call communication; a controller 407 for generating road guidance information based on the matched map information (map matching results), and determining whether or not an intersection can be entered based on the traffic light information and the traffic violated vehicle information when the vehicle enters the intersection on the route; a display unit 405 for displaying a road guidance map (including information about a point of interest (POI)) included in the road guidance information and the traffic light information; and a voice output unit 406 for outputting road guidance voice information (road guidance voice message) included in the road guidance information and a voice signal corresponding to the traffic light information. Here, the traffic violated vehicle speed may be measured by a vehicle speed sensor (not shown) installed at each of the traffic lights. The traffic violated vehicle information may include speed information of the traffic violated vehicle.

FIG. 22 is a flow chart illustrating the process of a navigation method (vehicle navigation method) according to a third exemplary embodiment of the present invention. The navigation apparatus and method allowing for safely entering the intersection based on traffic violated vehicle information and the speed of the traffic violated vehicle as well as traffic light information according to the third exemplary embodiment of the present invention will now be described.

First, the communication unit 408 acquires traffic light information at a current time point (S41). For example, the communication unit 408 receives traffic light information and traffic light location information from a plurality of traffic lights installed at the intersection, and outputs the received information to the controller 407. In this case, the controller 407 determines a traffic light located in the current traveling direction of a vehicle by comparing traffic light location information and the current traveling direction of the vehicle, extracts traffic light information which has been transmitted from the determined traffic light, and displays the extracted traffic light information to the display unit 405.

The controller 407 receives each traffic light information and each traffic light location information and checks whether or not the vehicle is currently driving or in a stop state (S42). Here, the controller 407 may check whether or not the vehicle is currently driving or in a stop state from GPS data inputted via the GPS module 401 or data inputted from a wheel speed sensor (not shown) that provides average speed information of a vehicle.

When the vehicle is currently driving, the controller 407 calculates a time duration t1 required for the vehicle to reach the traffic light from the current time point, and calculates a time duration t2 required for the signal of the current traffic light (e.g., the vehicle travel signal (green)) to be changed to a stop signal (e.g., the vehicle stop signal (red)) from the current time point (S43). Here, the controller calculates the distance from the location of the traffic light to the current location of the vehicle based on the location information of the traffic light and divides the calculated distance by a current speed value of the vehicle to obtain the time t1 required for the vehicle to reach the traffic light.

The controller 407 determines whether or not the time duration t2 during which the signal of the current traffic light is changed to a stop signal is larger than the time duration t1 taken for the vehicle to reach the traffic light (S44). If the time duration t2 during which the signal of the current traffic light is changed to a stop signal is smaller than the time duration t1 taken for the vehicle to reach the traffic light, the controller 407 outputs a guidance voice regarding a signal change time point via the voice output unit 406 (S46). Namely, the controller 407 determines that the vehicle cannot safely pass through the traffic light and outputs a guidance voice regarding a signal change at a certain time point before the signal of the traffic light is changed.

Meanwhile, if the time duration t2 during which the signal of the current traffic light is changed to a stop signal is larger than the time duration t1 taken for the vehicle to reach the traffic light, the controller 407 determines whether or not there is a traffic violated vehicle (e.g., a traffic violated vehicle at the intersection) (S45). For example, each of the traffic lights installed at the intersection detects a traffic violated vehicle based on a vehicle detection signal detected by the vehicle sensor (not shown) buried in the road and transmits the detected traffic violated vehicle information (including the speed information of the traffic violated vehicle) to the communication unit 408 of the navigation apparatus 400 via the wireless communication network.

When the traffic violated vehicle information is received while the time duration t2 during which the signal of the current traffic light is changed to a stop signal is larger than the time duration t1 taken for the vehicle to reach the traffic light, the controller 407 generates intersection entry danger information and outputs the generated intersection entry danger information to the display unit 405 and/or to the voice output unit 406 (S47).

The controller 407 outputs the intersection entry danger information, extracts (detects) the traffic violated vehicle speed included in the traffic violated vehicle information, and outputs the extracted traffic violated vehicle speed to the display unit 405 and/or to the voice output unit 406 (S48).

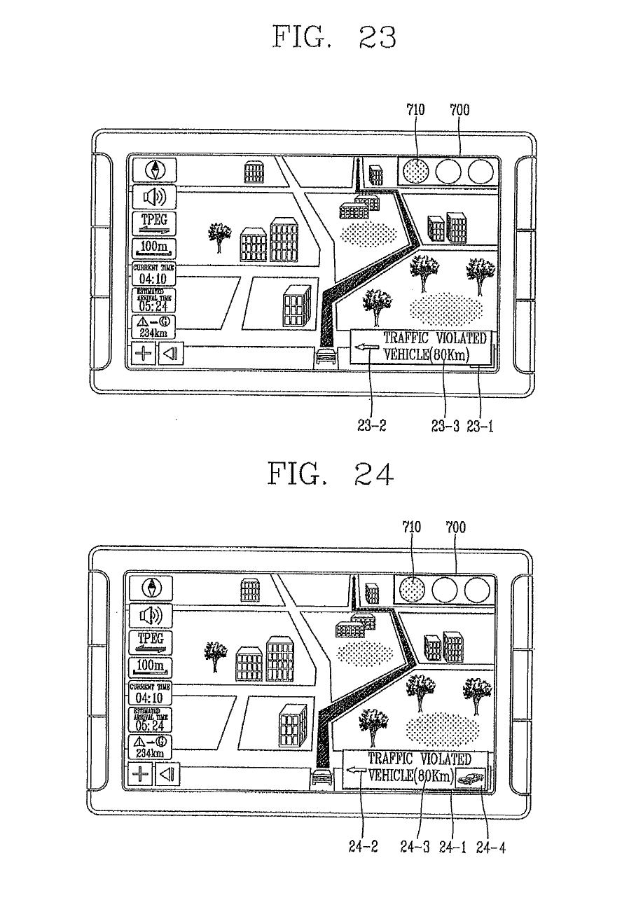

Hereinafter, the traffic violated vehicle speed displayed together with the intersection entry danger information will now be described with reference to FIG. 23.

FIG. 23 is an overview of a screen display illustrating a traffic violated vehicle speed displayed together with the intersection entry danger information according to the third exemplary embodiment of the present invention.

As shown in FIG. 23, when the time duration t2 during which the signal of the current traffic light (e.g., green signal) is changed to a stop signal (e.g., a red signal) is larger than the time duration t1 taken for the vehicle to reach the traffic light and the traffic violated vehicle information is received, the controller 407 detects a traffic light which has transmitted the traffic violated vehicle information via the traffic light location information. If the detected traffic light is currently positioned at the left side of the vehicle based on the current location of the vehicle, the controller recognizes (regards) that the traffic violated vehicle has violated the traffic on the left road based on the current location of the vehicle and generates information 23-2 (e.g., an icon or a symbol (e.g., an arrow indicating the left direction) indicating the direction in which the recognized traffic violated vehicle is located (e.g., the left direction) together with the intersection entry danger information 23-1 and traffic violated vehicle speed information (e.g., 80 Km) 23-3, and displays the generated information 23-2 and 23-3 and the intersection entry danger information 23-1 on the display unit 405. In this case, the controller 407 may generate voice information (e.g., ‘There is a traffic violated vehicle which runs at 80 Km at the left side. Please make a safe driving’) corresponding to the intersection entry danger information 23-1, the direction information 23-2 indicating that the traffic violated vehicle was generated, and the traffic violated vehicle speed information 23-3, and output the voice signal to the voice output unit 406.

Meanwhile, if no traffic violated vehicle information is received while the time duration t2 during which the signal of the current traffic light (e.g., green signal) is changed to a stop signal (e.g., a red signal) is larger than the time duration t1 taken for the vehicle to reach the traffic light, the controller 407 determines that the vehicle can safely pass through the traffic light at the current traveling speed (S49).

When the vehicle is in a stop state (S50), the controller 407 outputs a broadcast via the voice output unit 406 at a certain time before the signal is changed to the direction consistent with the guiding direction in the travel route (S51).

Hereinafter, a method of displaying intersection entry danger information according to a fourth exemplary embodiment of the present invention will now be described with reference to FIG. 24.

FIG. 24 is an overview of a screen display illustrating a method of displaying intersection entry danger information according to a fourth exemplary embodiment of the present invention.

As shown in FIG. 24, when the time duration t2 during which the signal of the current traffic light (e.g., green signal) is changed to a stop signal (e.g., a red signal) is larger than the time duration t1 taken for the vehicle to reach the traffic light and the traffic violated vehicle information is received, the controller 407 detects a traffic light which has transmitted the traffic violated vehicle information via the traffic light location information. If the detected traffic light is currently positioned at the left side of the vehicle based on the current location of the vehicle, the controller recognizes (regards) that the traffic violated vehicle has violated the traffic on the left road based on the current location of the vehicle and generates information 24-2 (e.g., an icon or a symbol (e.g., an arrow indicating the left direction) indicating the direction in which the recognized traffic violated vehicle is located (e.g., the left direction) together with the intersection entry danger information 24-1 and the traffic violated vehicle speed information (e.g., 80 Km) 24-3 and displays the generated information 24-2 and 24-3 and the intersection entry danger information 24-1 on the display unit 405. In this case, the controller 407 may detect an image of the traffic violated vehicle from the traffic violated vehicle information, and display the detected image 24-4 of the traffic violated vehicle together with the intersection entry danger information 24-1, the direction information 24-2 indicating that the traffic violated vehicle was generated, and the traffic violated vehicle speed information 24-3 on the display unit 405.

Hereinafter, a navigation apparatus and method allowing for a stable entering an intersection based on traffic volume information (e.g., inlet traffic volume (traffic flow information and traffic congestion information) at an intersection) as well as traffic light information will now be described.

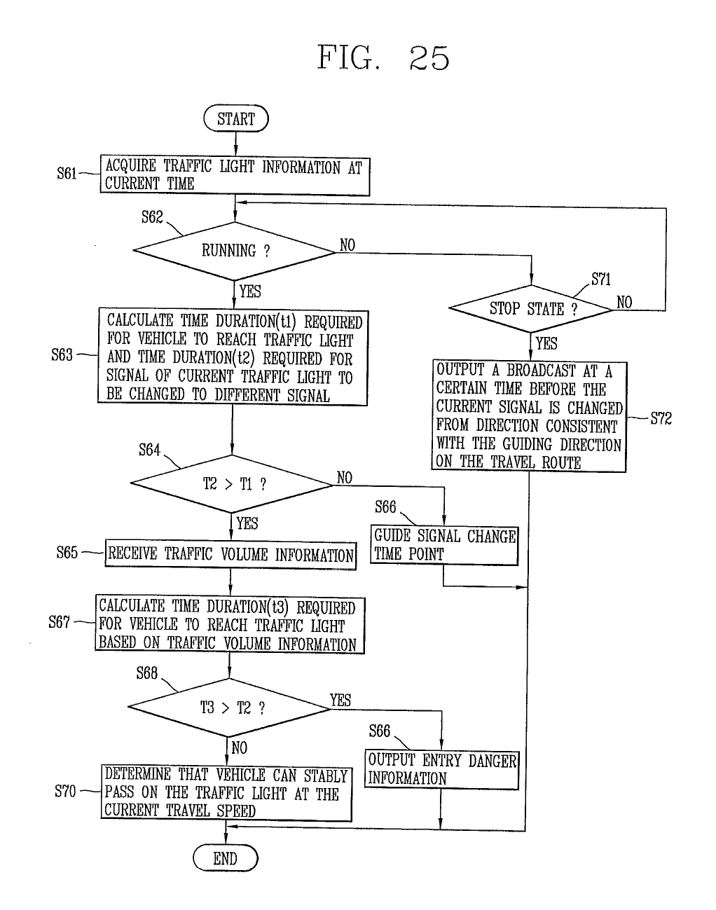

FIG. 25 is a flow chart illustrating the process of a navigation method (vehicle navigation method) according to a fifth exemplary embodiment of the present invention. Here, each of the traffic lights at the intersection receives traffic volume information (vehicle flow information) of the common section 17-A and the individual section 17-B of the intersection from the vehicle sensor installed at the road (intersection), and transmits the traffic volume information to every vehicle around the intersection. The traffic volume information may include information regarding an average link speed, a travel time, a link delay, and a congestion type. For example, the vehicle sensor installed at the road (intersection) is buried in the road (e.g., the intersection), sequentially detects the speed of a vehicle running on the intersection, and transmits the detected vehicle speed to the traffic lights. In this case, the traffic light may calculate an average speed of the vehicles running on the intersection based on the vehicle speed sequentially transmitted from the vehicle sensor, and transmit the calculated vehicle average speed to all the vehicles around the intersection via a communication unit (not shown). Thus, the navigation (vehicle navigation) method of a mobile terminal according to a fifth exemplary embodiment of the present invention can determine the traffic volume (congestion) at the intersection based on the average speed of the vehicles running on the intersection.

First, the communication unit 408 acquires traffic light information at a current time point (S61). For example, the communication unit 408 receives traffic light information and traffic light location information from a plurality of traffic lights installed at the intersection, and outputs the received information to the controller 407. Then, the controller 407 determines a traffic light located in the direction in which the vehicle is currently driving by comparing each traffic light location information and the current driving direction of the vehicle, extracts traffic light information which has been transmitted from the determined traffic light, and displays the extracted traffic light information on the display unit 405.

The controller 407 receives each traffic light information and each traffic light location information, and checks whether or not the vehicle is currently driving or in a stop state (S62). Here, the controller 407 may check whether or not the vehicle is currently driving or in a stop state from GPS data inputted via the GPS module 401 or data inputted from a wheel speed sensor (not shown) that provides average speed information of a vehicle.

When the vehicle is currently driving, the controller 407 calculates a time duration t1 required for the vehicle to reach the traffic light from the current time point at the vehicles current speed, and calculates a time duration t2 required for the signal of the current traffic light (e.g., the vehicle travel signal (green)) to be changed to a stop signal (e.g., the vehicle stop signal (red)) from the current time point (S63). Here, the controller calculates the distance from the location of the traffic light to the current location of the vehicle based on the location information of the traffic light and divides the calculated distance by a current speed value of the vehicle to obtain the time t1 required for the vehicle to reach the traffic light.

The controller 407 determines whether or not the time duration t2 during which the signal of the current traffic light is changed to a stop signal is larger than the time duration t1 taken for the vehicle to reach the traffic light (S64). If the time duration t2 during which the signal of the current traffic light is changed to a stop signal is smaller than the time duration t1 taken for the vehicle to reach the traffic light, the controller 407 outputs a guidance voice regarding a signal change time point via the voice output unit 406 (S66). Namely, the controller 407 determines that the vehicle cannot safely pass through the traffic light and outputs a guidance voice regarding a signal change at a certain time point before the signal of the traffic light is changed.

Meanwhile, if the time duration t2 during which the signal of the current traffic light is changed to a stop signal is larger than the time duration t1 taken for the vehicle to reach the traffic light, the controller 407 receives traffic volume information from the traffic light via the communication unit 408 (S65). Here, the traffic light detects average vehicle speed at the intersection and transmits traffic volume information including the average vehicle speed to the communication unit 408.

When the time duration t2 during which the signal of the current traffic light is changed to a stop signal is larger than the time duration t1 taken for the vehicle to reach the traffic light, the controller 407 calculates a time duration t3 required for the vehicle to reach the traffic light based on the traffic volume information received via the communication unit 408 (S67). For example, the controller detects a distance value from the location of the traffic light to the current vehicle and divides the distance value by the average vehicle speed at the intersection to detect the arrival time t3 from the current vehicle to the traffic light.

When the average vehicle speed at the intersection is lower than a reference speed (e.g., below 10 Km/h) while the signal of the traffic light is a vehicle travel signal, the controller 407 may determined that a traffic congestion level exceeds a reference level, and when the average vehicle speed at the intersection exceeds the reference speed (e.g., above 10 Km/h), the controller 407 may determine that the traffic congestion level is lower than the reference level. In this case, when the traffic congestion level exceeds the reference level, the controller 407 outputs the intersection entry danger information, and when the traffic congestion level is lower than the reference level, the controller 407 outputs an intersection entry safe message. Here, the traffic volume information corresponds to the route, and the controller 407 indicates the traffic congestion level at the intersection based on the average vehicle speed at the intersection.

When the time duration t3 required for the current vehicle to reach the traffic light is larger than the time duration t2 taken for the signal of the traffic light to be changed to a stop signal based on the traffic volume information (S68), the controller 407 generates the intersection entry danger information and outputs the generated intersection entry danger information to the display unit 405 and/or to the voice output unit 406 (S69).

Meanwhile, when the time duration t2 taken for the signal of the traffic light to be changed to a stop signal is larger than the time duration t3 required for the current vehicle to reach the traffic light, the controller 407 determines that the vehicle can safely pass through the traffic light (intersection) at the current traveling speed (S70).

When the vehicle is in a stop state (S71), the controller 407 outputs a broadcast via the voice output unit 406 at a certain time before the signal is changed to the direction consistent with the guiding direction in the travel route (S72).

Meanwhile, in the navigation (vehicle navigation) apparatus and method of the mobile terminal according to an exemplary embodiment of the present invention, when the time duration t2 taken for the signal of the traffic light to be changed to a stop signal is larger than the time duration t1 required for the current vehicle to reach the traffic light, the controller 407 detects a time duration t3 required for the current vehicle to reach the vehicle ahead (vehicle immediately in front of the current vehicle). If the time duration t3 required for the current vehicle to reach the vehicle ahead is smaller than the time duration t1 required for the current vehicle to reach the traffic light, the controller 407 generates intersection entry danger information in order to prevent a collision between the current vehicle and the vehicle ahead, and outputs the generated intersection entry danger information to the display unit 405 and/or to the voice output unit 406. For example, the controller 407 may receive the location of the vehicle ahead of the current vehicle from the traffic light, detect a distance value between the current vehicle and the vehicle ahead based on the location of the vehicle ahead and the location of the current vehicle, and divide the distance value by the speed of the current vehicle to detect the arrival time duration t3 required for the current vehicle to reach the vehicle ahead.

Here, the traffic light receives location information and route information from the nearby vehicles via a wireless communication network, and transmits the location information to the controller 407 via the communication unit 408. Also, the traffic light sequentially may detect the speed of first and second vehicles via the vehicle sensor (not shown) that detects a driving vehicle at a fixed location and a vehicle detection time (namely, a vehicle detection time detected at the location of the vehicle sensor), and transmit the speed of the first vehicle and the vehicle detection time to the second vehicle, to thereby detect a time duration required for the second vehicle to reach the first vehicle.

For example, if the speed of the first vehicle is 80 Km/h, the vehicle detection time is 10:00:00 a.m., the speed of the second vehicle is 80 Km/h, and the vehicle detection time is 10:00:30 a.m., then the time duration required for the second vehicle to reach the first vehicle (the vehicle ahead of the second vehicle) is 30 seconds.

The controller 407 may detect the location of the vehicle ahead of the current vehicle through an ultrasonic wave signal. For example, an ultrasonic wave transmission/reception unit (not shown) for transmitting and receiving an ultrasonic wave signal may be attached on a front surface (e.g., a bumper of the vehicle) of the vehicle, an ultrasonic wave signal is transmitted to the vehicle ahead of the current vehicle, the ultrasonic wave signal reflected from the vehicle ahead is received, a distance value between the current vehicle and the vehicle ahead is calculated based on the difference value (time difference) between the transmission time and the reception time of the ultrasonic wave signal, and the calculated distance value is divided by the speed of the current vehicle, to thereby detect the time duration t3 required for the current vehicle to reach the vehicle ahead.

Meanwhile, when the arrival time duration t3 is larger than the time duration t1 required for the vehicle to reach the traffic light, the controller 407 determines that the vehicle can safely pass through the traffic light at the current traveling speed, generates an entry safe message, and outputs the entry safe message to the display unit 405 and/or to the voice output unit 406.

As so far described, the navigation method and apparatus of the mobile terminal according to the exemplary embodiments of the present invention have many advantages as follow.

First, because the information of the traffic light located at each road section is provided to the vehicle driver, accurate road situation can be provided to the vehicle driver.

Second, because the signal information of the traffic light is audibly guided, the user convenience can be improved.

Third, because whether or not an intersection can be entered is provided to the vehicle driver based on the traffic light information and traffic volume information (traffic congestion degree), the vehicle driver can safely drive on the road (e.g., the intersection).

Fourth, because the traffic light information and the traffic violated vehicle information are provided to the vehicle driver, the vehicle driver can safely drive on the road (e.g., the intersection).

As the present invention may be embodied in several forms without departing from the characteristics thereof, it should also be understood that the above-described embodiments are not limited by any of the details of the foregoing description, unless otherwise specified, but rather should be construed broadly within its scope as defined in the appended claims, and therefore all changes and modifications that fall within the metes and bounds of the claims, or equivalents of such metes and bounds are therefore intended to be embraced by the appended claims.

What is claimed is:

1. A navigation apparatus for use with a transportation device, the apparatus comprising:
a display unit configured to display, on map data, a route for the transportation device to move from a current location to a destination;
a communication unit configured to receive light signal information for at least one traffic light at an intersection on the route, and to receive traffic volume information associated with the route; and
a controller configured to notify traffic light signal navigation information related to a movement of the transportation device through the at least one traffic light, based on the light signal information and the traffic volume information.

2. The apparatus of claim 1, wherein the controller indicates a traffic congestion level of the intersection based on an average vehicle speed at the intersection.

3. The apparatus of claim 2, wherein the controller outputs intersection entry danger information if the traffic congestion level exceeds a reference level.

4. The apparatus of claim 3, wherein if the average vehicle speed at the intersection is lower than a reference speed, the controller regards the traffic congestion level as exceeding the reference level, and if the average vehicle speed at the intersection exceeds the reference speed, the controller regards the traffic congestion level as being lower than the reference level.

5. The apparatus of claim 2, wherein the controller calculates a first time duration required for a vehicle to reach the traffic light based on a current vehicle location and speed and a second time duration required for the vehicle traffic signal of the traffic light to be changed to a stop signal,
wherein when the second time duration is greater than the first time duration, the controller calculates a third time duration required for the vehicle to reach the traffic light from its current location by dividing a distance value from the location of the traffic light to the current location of the vehicle by the average vehicle speed at the intersection, and
wherein when the third time duration is greater than the second time duration, the controller outputs the intersection entry danger information.

6. The apparatus of claim 1, wherein the controller receives traffic light location information from the traffic light via the communication unit, and displays signal information of the traffic light which has been transmitted from a traffic light located in a current direction of the transportation device.

7. The apparatus of claim 1, wherein when traffic violated vehicle information is received from the traffic light, the controller outputs intersection entry danger information.

8. The apparatus of claim 7, wherein the controller calculates a first time duration required for a vehicle to reach the traffic light based on a current vehicle location and speed and a second time duration required for the vehicle traffic signal of the traffic light to be changed to a stop signal, and
wherein if the traffic violated vehicle information is received and the second time duration is greater than the first time duration, the controller outputs the intersection entry danger information.

9. The apparatus of claim 8, wherein if the traffic violated vehicle information is received when the second time duration is greater than the first time duration, the controller provides a direction of the traffic violated vehicle.

10. The apparatus of claim 9, wherein if the traffic violated vehicle information is received when the second time duration is greater than the first time duration, the controller detects a traffic light which has transmitted the traffic violated vehicle information, recognizes the direction of the detected traffic light as the direction of the traffic violated vehicle, and outputs information indicating the direction of the traffic violated vehicle and the intersection entry danger information.

11. The apparatus of claim 9, wherein the controller detects the speed of the traffic violated vehicle and displays the detected speed on the display unit.

12. The apparatus of claim 9, wherein the controller receives a photo image of the traffic violated vehicle, and displays the detected photo image on the display unit.

13. A navigation method for a transportation device, the method comprising:
displaying, by a display unit, on map data a route from a current location to a destination;
receiving, by a communication unit, light signal information for at least one traffic light at an intersection on the route, and receiving traffic volume information associated with the route; and
notifying traffic light signal navigation information related to a movement of the transportation device through the at least one traffic light based on the light signal information and the traffic volume information.

14. The method of claim 13, wherein the notifying traffic light signal navigation information comprises:
indicating a traffic congestion level at the intersection based on the average vehicle speed at the intersection included in the traffic volume information.

15. The method of claim 14, wherein the notifying traffic light signal navigation information comprises:
outputting an intersection entry danger information if the traffic congestion level exceeds a reference level.

16. The method of claim 15, wherein the notifying traffic light signal navigation information comprises:
regarding the traffic congestion level as exceeding the reference level if the average vehicle speed at the intersection is lower than a reference speed, and regarding the traffic congestion level as being lower than the reference level if the average vehicle speed at the intersection exceeds the reference speed.

17. The method of claim 14, wherein the notifying traffic light signal navigation information comprises:
calculating a first time duration required for a vehicle to reach the traffic light based on a current vehicle location and speed and a second time duration required for the vehicle traffic signal of the traffic light to be changed to a stop signal,
wherein when the second time duration is greater than the first time duration, calculating a third time duration required for the vehicle to reach the traffic light from its current location by dividing a distance value from the location of the traffic light to the current location of the vehicle by the average vehicle speed at the intersection, and
wherein when the third time duration is greater than the second time duration, outputting the intersection entry danger information.

18. The method of claim 13, further comprising:
receiving traffic light location information from the traffic light via the communication unit, and
displaying signal information of the traffic light which has been transmitted from a traffic light located in a current direction of the transportation device based on the traffic light location information on the display unit.

19. The method of claim 13, further comprising:
outputting intersection entry danger information when traffic violated vehicle information is received from the traffic light.

20. The method of claim 19, wherein the notifying traffic light signal navigation information further comprises:
calculating a first time duration required for a vehicle to reach the traffic light based on a current vehicle location and speed and a second time duration required for the vehicle traffic signal of the traffic light to be changed to a stop signal, and
if the traffic violated vehicle information is received when the second time duration is greater than the first time duration, outputting the intersection entry danger information.

21. The method of claim 20, wherein the notifying traffic light signal navigation information further comprises:
if the traffic violated vehicle information is received when the second time duration is greater than the first time duration, providing a direction of the traffic violated vehicle.

22. The method of claim 21, wherein the providing the direction of the traffic violated vehicle comprises:
if the traffic violated vehicle information is received when the second time duration is greater than the first time duration, detecting a traffic light which has transmitted the traffic violated vehicle information,
recognizing a direction of the detected traffic light as a direction of the traffic violated vehicle, and
outputting information indicating the recognized direction of the traffic violated vehicle and the intersection entry danger information.

23. The method of claim 21, further comprising:
detecting the speed of the traffic violated vehicle; and
displaying the detected speed on the display unit.

24. The method of claim 21, further comprising:
receiving a photo image of the traffic violated vehicle; and
displaying the detected photo image on the display unit.
